(19) United States
(12) Patent Application Publication
(10) Pub. No.: US 2025/0227817 A1
(43) Pub. Date: Jul. 10, 2025

(54) WIRELESS POWER CONTROL OF RESONANT INDUCTION APPLIANCE SYSTEMS

(71) Applicant: Midea Group Co., Ltd., Foshan (CN)

(72) Inventor: Michael Grant, Taylorsville, KY (US)

(73) Assignee: Midea Group Co., Ltd., Foshan (CN)

(21) Appl. No.: 18/404,738

(22) Filed: Jan. 4, 2024

(51) Int. Cl. H05B 6/06; H02J 50/12; H02J 50/60; H05B 1/02; H05B 6/12

(52) U.S. Cl. CPC H05B 6/062; H02J 50/12; H02J 50/60; H05B 1/0266; H05B 6/1236

(57) ABSTRACT

Appliance control component(s) are described herein for determining whether an appliance system operator is present or not at a resonant induction appliance system comprising a wireless power receiver subsystem removably in a wireless power reception zone of a wireless power transmitter subsystem. While the operator is present, the appliance system operates to perform an appliance task. When the control component(s) determine that the appliance system operator is no longer present, the appliance control component(s) access a stored trigger and, based on the trigger, proceed to disable the appliance system by causing the transmitter subsystem to stop delivering enough wireless power to the receiver subsystem for the receiver subsystem to perform the potentially unattended work on the appliance task. The control component(s) also trigger a notification that the operational mode of the appliance system has been disabled to stop the potentially unattended work by the receiver subsystem on the appliance task.

### BACKGROUND

This disclosure relates in general to wireless powered appliance and, not by way of limitation, to the safety of wireless power appliances.

There are a wide variety of kitchen appliances available to perform a wide variety of appliance tasks. A blender blends a mixture together. A toaster heats up food. A coffee maker brews coffee. A kettle warms up water. A juicer squeezes juice from fruits. Many of these kitchen appliances have been around for our lifetime with little overall change in how they work. New functions have been added, and new settings allow for more specifically handling different types of foods. An appliance operator still interacts with these devices in the same way, though, by plugging them into the wall and pressing a button, or perhaps a touch screen.

Induction kettles have been around for many years but have become much more popular in the past decade. With an induction kettle, a cord plugs into the wall to electrify a base. The base then supplies power to the kettle wirelessly, through a process of induction, to heat up the water in the kettle.

The past decade has also seen a rise in induction cooktops, where pots and pans can be placed on flat surfaces, and the induction cooktop causes the pots and pans to heat up using power delivered from underneath the countertop, inductively.

With these appliances, the appliance operator still places the appliance into action by attending to the appliance task that is being performed. The appliance operator presses the button, or the touch screen, and the appliance performs the appliance task according to the specified setting. Whether powered with a cord or wirelessly, the task is carried out precisely according to the selections that were made. The automation of the full appliance task is part of the convenience of making initial selections tailored to the specific cooking or other appliance task being done.

### SUMMARY

In various embodiments, one or more appliance control components act to control the functionality and operation of an appliance system to promote safe operation of the appliance system. The control component(s) may include logic on the appliance system itself, a wireless transmitter subsystem of the appliance system, a wireless receiver subsystem of the appliance system, a mobile device application, and/or a server. The control component(s) determine whether an appliance system operator is present or not at a resonant induction appliance system comprising a wireless power receiver subsystem removably in a wireless power reception zone of a wireless power transmitter subsystem. While the operator is present, the appliance system operates to perform an appliance task. When the control component(s) determine that the appliance system operator is no longer present, the appliance control component(s) access a stored trigger and, based on the trigger, proceed to disable the appliance system by causing the transmitter subsystem to stop delivering enough wireless power to the receiver subsystem for the receiver subsystem to perform the potentially unattended work on the appliance task. The control component(s) also trigger a notification that the operational mode of the appliance system has been disabled to stop the potentially unattended work by the receiver subsystem on the appliance task.

In one embodiment, the control component(s) are configured to determine that an appliance system operator is present at a resonant induction appliance system comprising a wireless power receiver subsystem removably in a wireless power reception zone of a wireless power transmitter subsystem. For example, the control component(s) may determine that the appliance system operator is present at the resonant induction appliance system when it is detected that the wireless power receiver subsystem has been newly placed in the wireless power reception zone of the wireless power transmitter subsystem. The wireless power receiver subsystem comprises a wireless power receiver, and the wireless power transmitter subsystem comprises a wireless power transmitter. When the resonant induction appliance system is in an operational mode: the wireless power transmitter delivers enough wireless power to the wireless power receiver subsystem to allow the wireless power receiver subsystem to perform active work on an appliance task, such that the wireless power receiver subsystem consumes received power from the wireless power transmitter to perform the active work on the appliance task.

To promote safe operation of the resonant induction appliance system, based on determining that the appliance system operator is present at the resonant induction appliance system, the control component(s) are configured to enable the operational mode of the resonant induction appliance system to cause the wireless power transmitter to deliver enough wireless power to the wireless power receiver to allow the wireless power receiver subsystem to perform the active work on the appliance task, such that the wireless power receiver subsystem consumes the received power from the wireless power transmitter to perform the active work on the appliance task.

The control component(s) may then determine that the appliance system operator is no longer present at the resonant induction appliance system based on at least one metric collected using at least one device that is also not present at the resonant induction appliance system. The control component(s) access a stored trigger to determine that the trigger indicates that the operational mode of the resonant induction appliance system should be disabled based at least in part on the appliance system operator not being present at the resonant induction appliance system. The trigger promotes safe operation of the resonant induction appliance system by preventing potentially unattended work by the wireless power receiver subsystem on the appliance task.

In response to determining that the appliance system operator is no longer present at the resonant induction appliance system and that the trigger indicates that the operational mode of the resonant induction appliance system should be disabled based at least in part on the appliance system operator not being present at the resonant induction appliance system, the control component(s) may disable the operational mode of the resonant induction appliance system to cause the wireless power transmitter to stop delivering enough wireless power to the wireless power receiver subsystem for the wireless power receiver subsystem to perform the potentially unattended work on the appliance task, such that the wireless power receiver subsystem stops the potentially unattended work on the appliance task. Disabling the operational mode of the resonant induction appliance system also causes the control component(s) to trigger a notification that the operational mode of the resonant induction appliance system has been disabled to stop the potentially unattended work by the wireless power receiver subsystem on the appliance task.

In one embodiment, the wireless power receiver subsystem converts at least some of the received power into a current. The wireless power receiver subsystem further comprises an electric appliance having a physical interface, and the current is consumed by the electric appliance to perform the active work on the appliance task. In this embodiment, the control component(s) may determine that the appliance system operator is present at the resonant induction appliance system at least in part by detecting a physical interaction from the appliance system operator with the physical interface of the electric appliance.

In another embodiment, the wireless power receiver subsystem converts at least some of the received power into heat. The heat may cause one or more surfaces of the wireless power receiver subsystem to increase in temperature enough to perform the active work on the appliance task. The wireless power transmitter subsystem comprises a physical interface, such that the control component(s) determine that the appliance system operator is present at the resonant induction appliance system at least in part by detecting a physical interaction from the appliance system operator with the physical interface of the wireless power transmitter subsystem.

There are many techniques disclosed herein for detecting whether the operator is present or not at the appliance system. In one example, the control component(s) determine a trilaterated position of a mobile device of the appliance system operator, such that the trilaterated position may be compared to one or more stored positions relative to a location of the resonant induction appliance system to determine that the appliance system operator is no longer present at the resonant induction appliance system. The control component(s) may further access a stored policy to determine whether the trilaterated position is considered present at the resonant induction appliance system.

In another example of detecting that the operator is absent from the appliance system, the wireless power transmitter subsystem wirelessly receives a particular encapsulated presence message from a mobile device of the appliance system operator. The wireless power transmitter subsystem then decapsulates the particular presence message to determine that the appliance system operator is present at the resonant induction appliance system. Later, when it is determined that the appliance system operator is no longer present at the resonant induction appliance system, the wireless power transmitter subsystem makes this determination by failing to receive a later encapsulated presence message from the mobile device of the appliance system operator for a period of time after the particular encapsulated presence message was received.

The wireless power transmitter subsystem may support a plurality of different candidate wireless power receiver subsystems. In one example, the wireless power transmitter subsystem wirelessly receives an encapsulated message from the wireless power receiver subsystem. The wireless power transmitter subsystem then decapsulates the message to determine an identity of the wireless power receiver subsystem among the plurality of different candidate wireless power receiver subsystems. The control component(s) may access the trigger by looking up the trigger based at least in part on the identity of the wireless power receiver subsystem. The trigger may be specific to the device with that identity, with specific rules on how much power and/or at what frequency the receiver subsystem should be given in different scenarios or at different times, for how long, whether the transmitter subsystem is a valid subsystem for delivering the power, what triggers should cause different power delivery modes to the receiver subsystem to be disabled, and/or what grace periods should be granted before disabling occurs.

In some examples, the trigger is specific to the operational mode of the wireless power receiver subsystem, such that different operational modes have different triggers. In one embodiment, the control component(s) determine that the operational mode of the resonant induction appliance system is associated with a particular operational mode of a plurality of different candidate operational modes of the wireless power receiver subsystem. The trigger indicates that the particular operational mode of the wireless power receiver subsystem should be disabled when the induction appliance system operator is not present at the resonant induction appliance system after a grace period of time. The control component(s) determine that the grace period of time is not yet met. Based on the grace period indicated by the trigger, the control component(s) postpone the disabling of the operational mode of the resonant induction appliance system. Later, the control component(s) determine that the grace period of time is met and disable the operational mode of the resonant induction appliance system based at least in part on determining that the grace period of time is met.

The control component(s) may provide a user interface, for example, through a mobile device, to verify whether the appliance operator is present or not. In one embodiment, before the grace period of time is met and after determining that the appliance system operator is no longer present at the resonant induction appliance system, the control component(s) output, on a mobile device of the appliance system operator, a preliminary notification that indicates the resonant induction appliance system is potentially operating under unsafe conditions. The preliminary notification comprises a user interface on the mobile device, and the user interface comprises at least one response option for the appliance system operator to indicate that the resonant induction appliance system is operating under safe conditions. According to the policy for the receiver subsystem, the control component(s) may disable the operational mode of the resonant induction appliance system after the appliance system operator fails to indicate, via the user interface, that the resonant induction appliance system is operating under safe conditions.

In one embodiment, appliance control component(s) are included on the wireless power transmitter subsystem. The transmitter subsystem may include a wireless power transmitter comprising a coil coupled with a series capacitor in a resonant chamber, the resonant chamber operatively connected to a power inverter. The wireless power transmitter can be positioned to provide wireless power to a wireless power reception zone where a wireless power receiver subsystem can be removably placed. When the resonant induction appliance wireless power transmitter subsystem is placed in an operational mode, the wireless power transmitter delivers enough wireless power to the wireless power receiver subsystem to allow the wireless power receiver subsystem to perform active work on an appliance task, such that the wireless power receiver subsystem consumes received power from the wireless power transmitter to perform the active work on the appliance task.

The appliance control component(s), including processor(s), of the transmitter subsystem may be operatively connected to one or more wireless communication devices to receive metric(s) collected, such as those from device(s) that are not present at the resonant induction appliance system. The appliance control component(s) of the transmitter subsystem be configured to access a trigger that indicates that the operational mode of the resonant induction appliance system should be disabled based at least in part on the appliance system operator not being present at the resonant induction appliance system. The appliance control component(s) of the transmitter subsystem may further be configured to, in response to determining that the appliance system operator is no longer present at the resonant induction appliance system and that the trigger indicates that the operational mode of the resonant induction appliance system should be disabled based at least in part on the appliance system operator not being present at the resonant induction appliance system, disable the operational mode of the resonant induction appliance system to cause the wireless power transmitter to stop delivering enough wireless power to the wireless power receiver subsystem for the wireless power receiver subsystem to perform the potentially unattended work on the appliance task, such that the wireless power receiver subsystem stops the potentially unattended work on the appliance task.

The appliance control component(s) on the wireless power transmitter subsystem may further be configured to cause triggering a notification that the operational mode of the resonant induction appliance system has been disabled to stop the potentially unattended work by the wireless power receiver subsystem on the appliance task.

As described, the appliance control component(s) that act to control the functionality and operation of the appliance system may be implemented on the appliance system itself, the wireless transmitter subsystem, the wireless receiver subsystem, the mobile device application, and/or the server. In one embodiment, the appliance control component(s) comprise processors operatively coupled to one or more non-transitory machine-readable storage media. The storage media stores instructions, such as machine-readable code, which when executed, cause performance of the steps of the processes described herein.

### BRIEF DESCRIPTION OF THE DRAWINGS

The present disclosure is described in conjunction with the appended figures:

FIG. 1 illustrates a diagram of an embodiment of an induction appliance system 100 including an electric appliance 126;

FIG. 2 illustrates a diagram of an embodiment of an induction appliance system 200 including magnetic cookware 226;

FIGS. 3A, 3B, and 3C illustrate a diagram of a building containing appliance system 302 and other beacons and signals nearby for determining whether an appliance system operator is present at appliance system 302;

FIG. 4 illustrates a circuit diagram of an embodiment of a relay circuit of the power transmission between a power receiver and a power transmitter;

FIG. 5 illustrates a flow diagram of an embodiment of a process for disabling an induction appliance system when an operator is not present at the induction appliance system;

FIG. 6 illustrates a network diagram of an embodiment of an induction appliance controller in communication with a smart phone and a server to control an induction appliance system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

### Induction Appliance Systems

Inductive power transfer to an induction appliance or conductive cookware occurs when a conductive coil, such as a copper coil shielded by ferrite, is located under a surface, such as a base, pad, a counter, or a cooktop, and the induction appliance or magnetic cookware is placed on the surface. A current can be produced in the coil by placing a positive terminal at one end of the coil and a negative terminal at the other end of the coil. Current will flow from the positive terminal to the negative terminal. When a current is passed through the coil, a magnetic field is produced that emanates from the coil. The direction of the magnetic field is determined based on the right-hand rule, which states that current traveling around the coil in the direction of the fingers on the right hand produces a magnetic field pointing in the direction of the thumb on the right hand. When alternating current (AC) power is used to generate the current in the coil, an alternating magnetic field penetrates the surface. In induction appliance systems, the magnetic field travels through the surface to a wireless power receiver.

Any conductive base, such as a pot, pan, or kettle placed on the surface above the coil, when exposed to the alternating magnetic field, will heat up due to electric currents, called eddy currents, produced inside the conductive base. When a ferromagnetic base, such as an iron pot, iron pan, or iron kettle is placed on the surface, additional heat is generated due to magnetic hysteresis. As current continues to flow through the coil, power is transferred from the coil to the conductive base. The coil or other electromagnetic-field-producing device is called a wireless power transmitter, and the conductive base or other device configured to receive the electromagnetic field and convert the field into heat or electricity is called a wireless power receiver. The wireless power transmitter may have one or more coils operating at same or different frequencies and with same or different currents, and the wireless power receiver may be positioned over one or multiple of the coils and have one or more of wireless power receiver coils.

An induction appliance system comprises a wireless power transmitter subsystem and a wireless power receiver subsystem. The wireless power transmitter subsystem is the portion of the induction appliance system that is able to provide wireless power, and the wireless power receiver subsystem is the portion of the induction appliance system that is able to receive wireless power and use the power to do work on an appliance task. The transmitter subsystem includes a power supply that provides input power, typically to a power inverter. The inverter provides DC/AC conversion and supplies energy to coil(s) for producing the magnetic field. In a resonant induction appliance system, the coil is coupled with a series capacitor in a resonant tank to improve the power transfer capability. While the wireless power transmitter subsystem is in an operational mode, the magnetic field emanates from the coil or resonant tank to a wireless power reception zone. The wireless power reception zone is a region on or near a surface where the wireless power receiver subsystem is removably located or can be newly placed. Due to the power delivery benefits obtained from a resonant induction appliance system, any or all of the induction appliance system embodiments described herein may be applied in a resonant induction appliance system to obtain these additional benefits.

An induction appliance system may have different types of wireless power transmitter or receiver subsystems. The wireless power transmitter subsystem may include or be placed under a surface, such as an induction base, pad, counter, table, cooktop, or other cooking surface such as the inside surfaces of an induction oven or turkey roasting pan, as well as a magnetic field generating coil below or within the surface. The wireless power transmitter subsystem may have different regions of surfaces supported by different coils and with different power delivery settings, frequencies, and power levels, such as a 4-zone cooktop or a 2-zone oven. In some embodiments, the transmitter subsystem is fixed below a countertop, fixed surface, or other installed location. In other embodiments, the transmitter subsystem comprises a coil-containing base that is movable on a countertop or any other convenient location. The transmitter subsystem may be hard-wired or otherwise connected to a high power (15-20 amps or more) supply line, such as a dedicated power supply line. In many of the transmitter subsystems that are movable rather than fixed, these transmitter subsystems often connect to a standard electrical outlet (up to 15-20 amps). The transmitter subsystems may have other components, such as one or more communication devices that send and/or receive messages according to communication protocols, such as the wireless communication protocols of Wi-Fi, Bluetooth, ZigBee, Z-wave, Bluetooth Low Energy, RFID, NFC, and/or Thread network communications.

The transmitter subsystem also includes a controller, such as a microcontroller, that operates using one or more storage devices and one or more processors to control the wireless power output and/or frequency; authenticate, identify, and/or complete handshake operations with receiver subsystems; access or retrieve triggers or policies that indicate the circumstances when power should or should not be delivered, and how much and of what frequency, to different types of receiver subsystems; receive, decapsulate, and store information from other devices according to the communication protocols; prepare messages to send to other devices according to the communication protocols; log communications that have been sent and received according to the communication protocols; log a history of power delivered over time or sessions with different receiver subsystems; and support application programming interfaces (APIs) that expose information and/or functionality to other devices such as a mobile application or to a receiver subsystem.

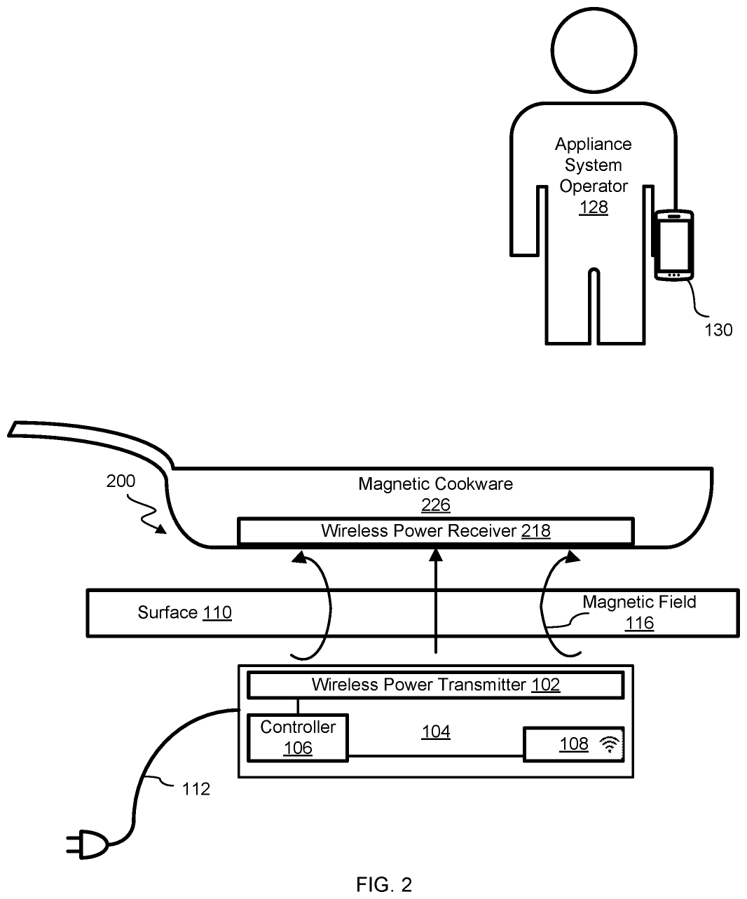

Different wireless power receiver subsystems may use different types of energy reception for different purposes. FIG. 2 illustrates a diagram of an embodiment of an induction appliance system 200 including magnetic cookware 226, which generates heat when exposed to a magnetic field from wireless power transmitter 102 of transmitter subsystem 104. Some wireless power receiver subsystems, such as magnetic cookware 226, rely on the same heat-generating process as described above with respect to conductive bases such as pots, pans, or kettles (often iron or another magnetic material) placed on an induction cooktop. For receiver subsystems that convert the wireless power received into heat, a conductive or magnetic surface, such as iron, placed near the coil of wireless power transmitter 102 will heat up due to the magnetic field 116 that is generated, and the induction appliance system 200 may use this heat for any purpose such as performing work on an appliance task. For example, an induction kettle (an example induction appliance system) may plug into the wall to power a base of the kettle (an example wireless power transmitter subsystem), and the base, when powered, produces a magnetic field that causes a surface in or on a basin of the kettle (an example wireless power receiver subsystem) to heat up. The heat generated in this example can be used for boiling water.

To promote safe operation of appliance system 200, in the example shown in FIG. 2, wireless transmitter subsystem 104 also includes a controller 106 for controlling whether to enable or disable wireless power to magnetic cookware 226. Wireless transmitter subsystem may communicate with an external server or with a smart phone application running on smart phone 130, using network device 108, to determine whether or not appliance system operator 128 is present at induction appliance system 200. As shown, power cord 112 supplies power to transmitter subsystem 104, which wirelessly transmits power, via magnetic field 116, through surface 110 to wireless power receiver 218. In this case, wireless power receiver 218 is the magnetic base of magnetic cookware 226.

In one embodiment, the wireless power receiver subsystem converts at least some of the received power into heat, and the heat causes one or more surfaces of the wireless power receiver subsystem to increase in temperature enough to perform active work on the appliance task. In this embodiment, the appliance system or a mobile device application may determine that the appliance system operator is present at the appliance system by detecting a physical interaction from the appliance system operator with the physical interface of the wireless power transmitter subsystem, such as the press of a button, turn of a knob, or a tap on a touchscreen of the transmitter subsystem.

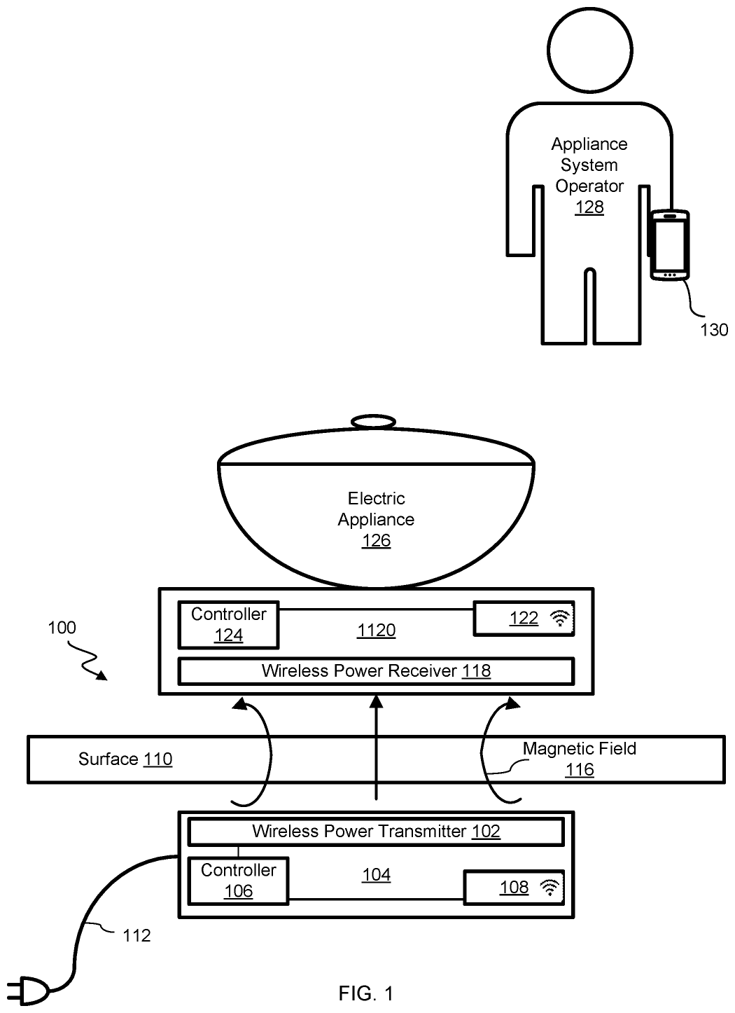

FIG. 1 illustrates a diagram of an embodiment of an induction appliance system 100 including an electric appliance 126. As illustrated in FIG. 1, another type of induction appliance system, instead of or in addition to converting the received magnetic field 116 into heat, the receiver subsystem 1120 also converts the magnetic field 116 back into electric current. This electric current can be used for any purpose, such as electrifying a blender, toaster, toaster oven, coffee maker, espresso machine, juicer, mixer, slow cooker, rice cooker 126, food processor, kettle, air fryer, steamer, hot plate, heater, fan, cooler, clothes iron, or any other appliance that uses electricity. The appliance may even incorporate a battery that is charged from the power of the magnetic field, so that the wireless power receiver subsystem may continue to be electrified even after being decoupled from the wireless power transmitter subsystem by moving the wireless power receiver subsystem away from the wireless power transmitter subsystem, or away from a wireless power reception zone on or near a surface of or above the wireless power transmitter subsystem.

In one embodiment, the wireless power receiver subsystem converts at least some of the received power into a current. The current allows the wireless power receiver subsystem to power an electric appliance, such as one having a physical interface for triggering an appliance task. The current is consumed by the electric appliance to perform active work on the appliance task. The appliance system may determine that the appliance system operator is present at the appliance system by detecting a physical interaction from the appliance system operator with the physical interface of the electric appliance, such as the press of a button, turn of a knob, or tap on a touchscreen of the receiver subsystem. Alternatively, the appliance system operator, a mobile device user, or a kitchen coordinator may communicate to appliance system 100 from smart phone 130 to wireless device 108 to signal that the appliance system operator is present and that operation of the device may begin or continue.

As shown in FIG. 1, wireless power transmitter subsystem 104 receives power from power cord 112, and, to promote safe operation of appliance system 100, includes controller 106 for controlling whether wireless power is enabled or disabled to receiver subsystem 1120. Wireless device 108 may communicate with a smart phone application on smart phone 130 to determine whether appliance system operator 128 is present or not at appliance system 100. If appliance system operator 128 is not present, controller 106 may disable power emitted from power transmitter 102 through surface 110 via magnetic field 116 to wireless power receiver 118. If appliance system operator 128 is present, controller 106 may continue to enable electric appliance 126 to work on an appliance task by supplying power through wireless power receiver 118 to receiver subsystem 1120.

Also as shown in the example of FIG. 1, receiver subsystem 1120 may include a wireless communications device 122, such as an NFC device, for communicating with transmitter subsystem 104. Information communicated may include an identification of the receiver subsystem 1120 as a rice cooker system. Receiver subsystem 1120 may also have controller 124 for controlling electric appliance 126 from an application on smart phone 130, or for modifying the impedance of wireless power receiver 118 to control the power received from wireless power transmitter 102.

When a wireless power receiver subsystem is placed in the reception zone, the wireless power transmitter subsystem may perform a handshake operation with introductory signals passed back and forth between the wireless power receiver subsystem and the wireless power transmitter subsystem. The handshake operation can establish how much power or the frequency of power desired by the wireless power receiver subsystem. Information identifying the receiver subsystem, and authentication information unique to the receiver subsystem, can also be passed to verify that the transmitter subsystem should proceed to provide power. The exchanged information can also be used to identify or establish policies for continuing or discontinuing the supply of wireless power to the wireless power receiver subsystem.

If the wireless power receiver subsystem is unable to perform the handshake operation, the wireless power transmitter subsystem may identify the receiver subsystem as either a heat producing device or a foreign object. This identification may be based on how efficiently the wireless power receiver is receiving power and converting the power into heat. For example, a set of keys might have the same inability to perform the handshake as an iron pan. The iron pan, with a large iron surface area parallel to the surface, has magnetic properties that allow it to efficiently convert a large amount of wireless power into heat, and the brass keys do not have this same property, and the wireless power transmitter subsystem can detect the keys as a foreign object to ensure that the large amount of wireless power is not delivered to the keys.

In another embodiment, the wireless power transmitter subsystem may immediately begin powering a wireless power receiver subsystem placed into the reception zone. For example, if the wireless power transmitter subsystem has been turned on physically with a knob, the induction appliance system may be configured to begin providing wireless power without performing a handshake operation. There are different types of wireless power transmitter subsystems available, such as different makes and models of induction cooktops, and each of these different types may have different settings, including different safety settings.

With or without a formal handshake operation, an induction cooktop or other wireless power transmitter subsystem may detect the heat-generating quality of the conductive base or other wireless power receiver subsystem based on how much of the alternating electromagnetic field is being lost to heat or conversion into electricity. The induction cooktop may cut off current to the conductive coil if the conductive base is not quickly enough converting the magnetic field to heat. For example, an induction cooktop may detect that an iron pan has been placed on the cooktop and proceed to heat up the pan by producing a magnetic field to be applied to the pan. The strength of the magnetic field or the frequency of the alternating magnetic field may be varied depending on how much heat is desired, as indicated by, for example, an adjustable knob or button on the induction cooktop. If a higher heat is indicated on the knob, for example, a lower operating frequency (for example, decreasing to 87 kHz from 205 kHz) or a stronger magnetic field may be applied to the pan.

In one embodiment, the induction appliance is powered according to the Ki™ standard (high current, currently up to 2200 watts), the Qi™ standard (currently less than 15 watts), or other power transfer protocols. According to these standards, a coil or array of coils in the power transmitter may have an outer diameter of approximately 50 mm or larger each. According to the standards, if the power receiver has a coil for converting the magnetic field back into electricity, the coil or array of coils in the power receiver may be approximately 40 mm or larger each, or preferably approximately the same size as the respective coil in the power transmitter. Maximum power transfer occurs when each of the coils in the power receiver is aligned or roughly aligned with a respective coil in the power transmitter when the power receiver is resting on the surface. A thicker surface, a larger power reception zone capable of powering receiver subsystems at a greater offset to the underlying coil(s), or otherwise a greater distance between the coil(s) and the receiver subsystems may be accommodated with larger coils and a greater current passing through the power transmitter coil(s).

In one embodiment, the induction appliance is powered using multiple channels or modes of inductive power from the wireless power transmitter subsystem. A first channel or mode of wireless power may include a small amount of energy that is just enough to power a display, LEDs, “ready” status indicators, other powered indicators on the wireless power receiver subsystem, and/or to retain any transiently stored settings such as the current time. A same coil or a different coil from the wireless transmitter subsystem may supply a second channel or mode of wireless power, which is sufficient to cause the wireless power receiver subsystem to enter operational mode and perform work on an appliance task using higher power input and output. Regardless of how many modes of power are used, the operational mode of the appliance system involves the delivery and consumption of enough power to support the appliance task, which may vary depending on how much power is demanded of the appliance task. Similarly, the wireless power receiver subsystem may have one coil or multiple coils for receiving the different channels or modes of wireless power from the transmitter subsystem. In one embodiment, the wireless power transmitter subsystem comprises different power reception zones corresponding to different levels of desired power, delivered by different coils with different power settings under the surface. In this embodiment, devices can be ensured to stay in low power mode if they remain in the low power regions.

In one embodiment, the induction appliance system, the transmitter subsystem, the receiver subsystem, or a mobile device in communication with the appliance system, transmitter subsystem, or receiver subsystem determines that an appliance system operator is present at the appliance system before allowing an appliance task to begin. Determining that the appliance system operator is present could be based on the occurrence of the appliance system operator pressing a button, touching a touchscreen, or performing another physical interaction with the appliance system itself, or the presence could be based on detecting that the wireless power receiver subsystem has been newly placed in the wireless power reception zone of the wireless power transmitter subsystem.

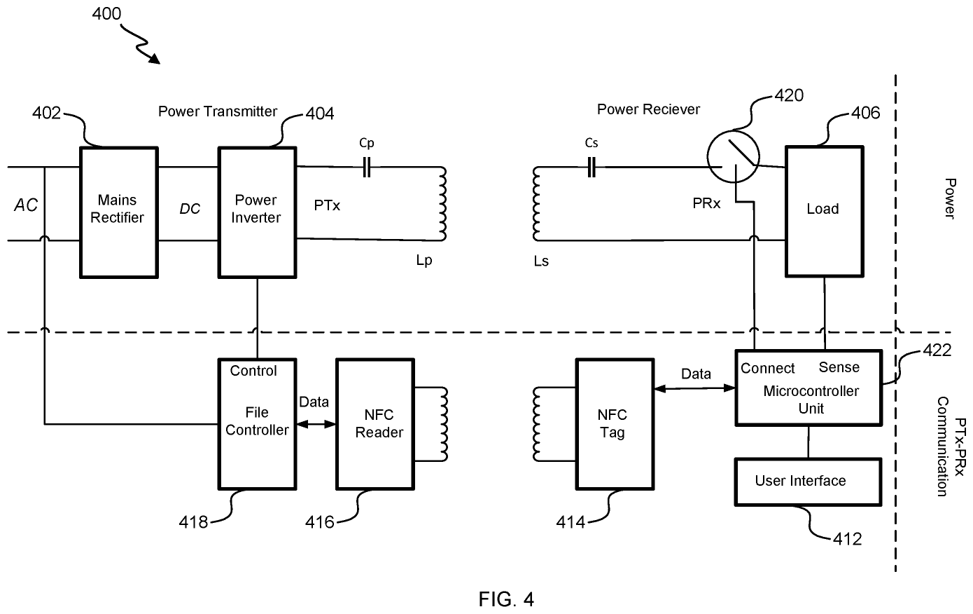

Referring to FIG. 4, a block diagram of an embodiment of a relay circuit 420 in a system of the resonant power transmission between a power receiver and a power transmitter. The resonant power transmission system contains a mains rectifier 402, a power inverter 404, a file controller 418, an NFC reader 416, a primary capacitance Cp and a primary coil Lp in the power transmitter. The power receiver includes a load 406, a microcontroller unit 422, a user interface 412, an NFC tag 414, a switch in a relay circuit 420, a secondary capacitance Cs and a secondary coil Ls. The mains rectifier 402 converts an AC supply (AC power) to a direct current (DC power). The power inverter 404 converts the DC power to high frequency alternating current (AC) power. The microcontroller unit 422 controls the amount and direction of the power transmission based on a data from the NFC reader 416. The NFC reader 416 reads the data from the power receiver, such as its identity, power level, load impedance, and/other settings, parameters, and configuration. If one-to-one communication between the power transmitter and the power receiver is established the file controller 418 will signal the power transmitter to transfer power. For example, Ki™ standard developed by a wireless power consortium entails authorized NFC communication before transferring the power to a high-power appliance.

In this implementation the resonant power transmission which is a method of transferring electrical energy without any direct electrical contact occurs when the power receiver and the power transmitter are tuned at a resonant frequency. The power transmitter generates a high frequency AC power to the primary coil Lp with a capacitor Cp in series. An electromagnetic flux is generated around the primary coil Lp, which induces a voltage in the secondary coil Ls of the power receiver. The microcontroller unit 422 will close the relay circuit 420 and allow the power to transfer to the load 406 of the power receiver. The microcontroller unit 422 also controls the user interface 412 of the appliance system. The user interface 412 contains buttons, LEDs, LCDs, etc. to give output or take input from an operator of the appliance system.

### Communication Between the Power Transmitter Subsystem and the Power Receiver Subsystem

There are several ways that information can be passed between the power transmitter subsystem and power receiver subsystem, bidirectionally or unidirectionally in either direction. In one embodiment, the power transmitter subsystem and power receiver subsystem both include one or more communication devices that send and/or receive messages according to one or more communication protocols, such as the wireless communication protocols of Wi-Fi, Bluetooth, ZigBee, Z-wave, Bluetooth Low Energy, RFID, NFC, and/or Thread network communications. The one or more communication devices may be separate from the core wireless power delivery mechanisms between the transmitter subsystem and receiver subsystem. Despite being separate from the power delivery mechanism, the transmitter subsystem's communication device is operatively coupled to the transmitter subsystem, and the receiver subsystem's communication device is operatively coupled to the receiver subsystem. Example wireless communication protocols include Wi-Fi, Bluetooth, ZigBee, Z-wave, Bluetooth Low Energy, RFID, NFC, and/or Thread network communications. If the transmitter subsystem has communication device(s) in addition to the wireless power transmitter itself, and the communication device(s) communicate with the receiver subsystem, the transmitter subsystem is called a multi-channel wireless device as it sends different wireless channels of signals to the receiver subsystem for different purposes.

Communication devices or other components can be detected or identified during an initial handshake using an introductory signal between the transmitter subsystem and the receiver subsystem. For example, the transmitter subsystem may include an NFC transceiver or other communication device to check for the presence of an NFC card or RFID tag. Detection of this device before entering an operational mode of power delivery allows the power transmitter subsystem to control the power delivery magnitude and frequency within bounds that will not damage the communication devices or other components. As another safeguard, the wireless communication devices and antennas, if any, can be placed external to the coil(s) of the wireless power transmitter subsystem, positioned and oriented to minimize the amount of magnetic energy absorbed by the device, with options for adding shielding to protect the communication devices or other components from the powered coil(s).

The wireless power transmitter and the wireless power receiver may additionally or alternatively communicate with each other directly by adjusting power transmission characteristics or power receiving characteristics. For example, the power receiver may modify or modulate the impedance or resistance being placed on the received power. Modulated impedance as low as 15 mA or 200 mV may be detected by the power transmitter based on how much or whether the signal has been weakened at different phases of transmission. The power receiver may send an initial signal indicating that it has information to communicate, and the power transmitter may enter a communication mode to efficiently transmit the information. Similarly, the power transmitter can modify the operating frequency of the signal to communicate information to the power receiver. These communications may include an initial advertisement or introductory signal to communicate or other handshake process to establish communication, and the communication may include just payload data or a packet comprising a header and/or other encapsulation followed by payload data. This data can be sent in either direction, and, in bidirectional communication, an optional acknowledgement can be sent to indicate that the packet of data has been correctly received.

In one embodiment, the communications between the power transmitter subsystem and power receiver subsystem are encrypted using a shared public key of the power receiver subsystem and/or the power transmitter subsystem, such that each communication partner can use a wireless communication protocol to retrieve the shared key or utilize a built-in lookup table to determine the shared key. By using a public key that is shared only with trusted partners that make complimentary products, the power transmitter and power receiver can be protected against untrusted access to the device that could create safety hazards and otherwise endanger appliance users. Also, if the encryption handshake between the power transmitter subsystem and power receiver subsystem uses separate public keys for each manufacturer, product, or unit, and if the communications between the power transmitter and receiver are logged, any unwanted access can be traced back to a specific otherwise trusted partner. The encryption can be further improved by having the power transmitter subsystem and/or receiver subsystem sign a certificate with a private key specific to the manufacturer, product, or unit. Proof of a valid signed certificate can be provided in a challenge phase of authentication between the power transmitter subsystem and receiver subsystem.

Regardless of the mode of communication between the power transmitter subsystem and the power receiver subsystem, such communication may occur for a variety of reasons. One such reason is to establish the identity of the power receiver subsystem. In one embodiment, the power transmitter subsystem initially transmits an introductory signal (for example, a low power signal, an NFC signal, an RFID signal, or any other wireless communication signal) to the power receiver subsystem to identify the power receiver subsystem or the type of power receiver subsystem. The power transmitter subsystem may access stored information such as receiver subsystem profiles, policies, metadata, or routines, either locally or remotely via contact with a smart phone or server via a wireless communication device on the power transmitter subsystem. The stored information may indicate whether the power receiver subsystem is allowed to receive anything more than the introductory signal. The stored information may further indicate what range, in terms of amplitude and/or frequency, of power that the power receiver subsystem is allowed to receive, or any other policies and routines to control or limit operation of the power receiver subsystem.

The introductory signal that starts the initial handshake is designed to be low enough power that it does not damage communication devices, and at a frequency that is compatible with communication devices that are desired to be detected. The transmitter subsystem may send out the introductory signal periodically and frequently, for example (e.g., 1-10 times per second) enough that new objects in the wireless power reception zone are quickly detected. If new impedance is detected on one of the wireless communication devices, the transmitter system may proceed to determine what is causing the impedance. If an object is detected that does not respond to any of the checks for known wireless communication protocols, and the object does not just absorb a high percentage of the energy like an iron pan, the transmitter subsystem may determine that the object is a foreign object placed in the wireless power reception zone. By being conductive, the foreign objects may briefly consume a small amount of power from the introductory signal and convert it into a miniscule amount of heat, likely unnoticeable to the touch. This power loss, signal distortion, or interference is detectable by the wireless power transmitter subsystem, which, in one embodiment, disables or decreases the magnitude or adjusts the frequency of the signal in response to detecting the foreign object. Then, the wireless power transmitter subsystem may periodically check if the foreign object is still present and re-enable or increase the signal when the foreign object is removed.

In one embodiment, the wireless power transmitter subsystem identifies the wireless power receiver subsystem based on the level of power or frequencies of power the wireless power receiver subsystem consumes (e.g., baseline or extended, or on a scale of 1-10, relative or absolute values in terms of watts or hertz, etc.). This allows the wireless power transmitter subsystem to determine how much power to deliver to the wireless power receiver subsystem. In the same or another embodiment, the wireless power receiver subsystem identifies the wireless power transmitter subsystem based on the level of power or frequencies of power the wireless power transmitter subsystem is capable of delivering.

In one embodiment, communication between the power transmitter subsystem and power receiver subsystem is performed to determine which operational mode is enabled or will be enabled when increased power is supplied by the power transmitter subsystem. For example, a toaster may indicate that a single piece of toast is being warmed, or that six pieces of frozen bread are being toasted. The power transmitter subsystem may then look up expected ranges of power use by the power receiver subsystem to determine whether power delivery is still falling within those ranges. The expected magnitude of power, frequency of power, and/or duration of power may change significantly depending on the setting being used. In one embodiment, the power receiver subsystem sends, via a wireless communication protocol, metadata (such as expected power, frequency, and/or duration, or other data mapped to power, frequency, and/or duration) to the wireless transmitter subsystem whenever a particular setting is selected on the wireless receiver subsystem, or as the wireless receiver subsystem begins to operate in a particular operational mode according to a selected setting.

Even without communicating a precise setting, the power transmitter subsystem may infer a setting based on the magnitude of power, frequency of power, and/or duration of power being delivered, as well as the time of day and history of device use. For example, if an appliance operator toasts a bagel every morning, the power transmitter subsystem may quickly learn the expected ranges of power, frequency, and duration, to power the toaster every morning. Similarly, if the appliance operator brews a pot of coffee at a certain time of day, the power transmitter subsystem may learn the expected ranges of power, frequency, and duration, to power the coffee maker at that time.

In one embodiment, whether the setting is communicated directly, learned based on history, or learned based on actual magnitude, frequency, and/or duration of power being consumed, any expectations for power delivery can be displayed on a touch screen interface of the power transmitter subsystem. In this manner, an appliance operator can verify that the power expected to be delivered corresponds to the setting pressed on the device and could make corrections on the touch screen if necessary.

### Safely Controlling Attended Appliances

Established power transfers between power transmitter subsystems and power receiver subsystems should be checked to ensure that power is being efficiently transferred, that heat is being maintained within safe ranges, that the structure of the power transmitter subsystem and power receiver subsystem are withstanding regular use, and, if the identity of the power receiver subsystem is being gathered, that the identity of intended power receiver subsystems can be distinguished from the identity of foreign objects. Adjustments may need to be made, for example, to the coil alignments, to the amplitude of power, to the operating frequency, to the conductivity and shielding of the coils, or to the magnetic, conductive, or shielding properties of elements in the power receiver subsystem.

After any adjustments in the design phase, the power receiver subsystem and power transmitter subsystem should operate together within safety limits. Even if the power transmitter subsystem is transmitting power to the power receiver subsystem in a manner that is set up by a human attendant, for example, by pressing button(s) and/or turning knob(s) to desired settings, those safety limits may still not be sufficient to protect nearby people and their environment, though. Human users are not perfect, and they often have busy lives involving many appliances and tasks that are all operational at the same time. To complicate matters, human users may be performing tasks in different spaces, and some of those tasks may involve interruptions or unexpected troubleshooting. People can be pulled to different rooms or even out of the house for other matters requiring their attention. These distractions can result in unsafe operation of the appliances not just to the appliance operator but to everyone in the building.

In one embodiment, attended appliances can be turned on, off, adjusted, and/or activated according to a particular setting using button(s), knobs, touchscreens, or other physical controls on the wireless power transmitter subsystem, on the wireless power receiver subsystem, or on a wirelessly connected switch, or using voice commands on the transmitter subsystem, receiver subsystem, a wirelessly connected switch, or a personal assistant device such as the Amazon Alexa™, Google Home™, or Apple™ HomePod™, Fire TV™, Chromecast™, Apple TV™ smart phone, etc. In another embodiment, attended appliances can be turned on, off, adjusted, and/or activated according to a particular setting using an interface on a smart phone application. For example, an appliance attendant may open the smart phone app, select a setting (e.g., a setting corresponding to a desired appliance task from a variety of different candidate appliance tasks), and proceed to have the appliance perform work on an appliance task according to the selected setting. In yet another embodiment, attended appliances can be turned on, off, adjusted, and/or activated according to voice commands given to a nearby virtual assistant. The virtual assistant may have an installed skill or application that receives intents or phrases, with potentially different intents mapped to different desired appliance tasks, from the appliance operator and converts those phrases into wireless commands, corresponding to the different desired appliance tasks, sent to the wireless power transmitter subsystem and/or the wireless power receiver subsystem to perform work on the corresponding appliance task. Some wireless power receiver subsystems may even be configured to turn on at a certain time of day, for example, to start brewing coffee.

Regardless of how the appliance is controlled by the attending appliance operator, there is still a safety problem when the appliance becomes unattended. The blender could fall over and endanger an animal or child. A toaster oven or kettle could heat up to the point of causing a fire. One problem that happens frequently, although not strictly a safety issue, is that expensive ingredients are ruined due to inattentiveness. In all of these scenarios, the appliance operator is likely no longer attendant to the appliance performing the appliance task. Instead, the appliance operator has been sidetracked while the appliance itself continues to consume the high power afforded by resonant induction appliance systems.

### Automatic Risk Mitigation for Unattended Appliances

Before the resonant induction appliance system can mitigate risk for unattended appliances, the resonant induction appliance system needs to be aware that the system is potentially unattended. There are many techniques disclosed herein for determining whether or not an induction appliance system is attended. Some techniques incorporate information gleaned from the induction appliance system itself, and other techniques incorporate information gleaned from other devices, such as the operator's mobile device, household Wi-Fi, cameras, etc. Once the appliance system is aware that the system is potentially unattended, the appliance system can operate to prevent potentially unattended work on any appliance tasks that may have otherwise been occurring.

In one embodiment, the resonant induction appliance system itself, or a mobile application or server in wireless communication with the system, determines a trilaterated position of a mobile device of the appliance system operator. The trilaterated position may be reported from GPS readings, Wi-Fi proximity/strength readings, Bluetooth, NFC, Thread network communications, or Ultra Wideband proximity/strength readings, cellular signals, altitude sensors, or other wireless location readings of one or more mobile devices associated with the appliance system operator and/or other members of her or his household, optionally at different times since the appliance system was placed in operational mode by the appliance system operator. The different locations may have different levels of confidence and may be weighted accordingly. For example, Bluetooth and Wi-Fi signal strengths fluctuate regularly with environmental interference, and accurate GPS readings can be difficult to obtain indoors. Also, although cellular signals are used to determine location (for example, in Enhanced 9-1-1 calls), the cellular signal determination may be less accurate in some situations, and weighted lower, than the more fine-grained readings from GPS, Bluetooth, and Wi-Fi. In one example, an altitude sensor on the user's mobile device may provide an indication of whether the user has gone to a different floor of the building.

In one embodiment, the position of the appliance system operator may be approximated based on a variety of readings collected about the mobile device of the appliance system operator as well as the appliance system operator herself or himself and/or an audible or visible environment near or away from the appliance system. For example, a proximity sensor near the appliance system may detect movement or proximity, leading to a higher likelihood score that there is an attendant nearby, and/or another proximity sensor away from the appliance system may not detect movement or proximity, leading to a further higher likelihood score that there is an attendant nearby. In the reversed example, the proximity sensor near the appliance system may not detect movement or proximity, leading to a lower likelihood score that there is an attendant nearby, and/or another proximity sensor away from the appliance system may detect movement or proximity, further lowering the likelihood score that there is an attendant nearby. Likelihood scores may be increased or decreased based on readings from a plurality of different devices, some of which may be co-located with the appliance system and others which may not be co-located with the appliance system, some of which may be measuring an immediate environment (sounds, video, proximity, etc.) and others of which may be wirelessly communicating with and measuring the mobile device location. In one example, sounds or even ultrasonic vibrations that are not audible to a human ear may be used to echolocate the boundaries and objects or people in a room. In a specific example, a mobile device of the user may detect or fail to detect a sound emitted from the appliance system or from a beacon near or away from the appliance system, audible or inaudible, in order to determine that the user is near or away from the appliance system, to an extent to be considered attendant or not attendant to the appliance system. In another example, background noise can be used to detect people nearby, such as people talking. An aggregate likelihood score may be used to determine whether the appliance system operator is present or not at the appliance system.

In some environments, getting a valid GPS or cellular signal could make it more likely that the operator is not attendant rather than attendant. In environments where the appliance system is nested on the interior of the home or otherwise not near any windows, or on a lower floor of a taller building, a GPS signal might be unexpected on the inside of the building and more expected on the outside. Similarly, while a home's interior Wi-Fi signal is usually stronger inside the home, a building lobby's Wi-Fi signal may be stronger if the operator has stepped outside the home, in the case of a high-rise. There may be neighbor Wi-Fi signals that can also be detected outside the home, which are stronger as the user goes away from the appliance system. In these scenarios, the presence of a signal might give a negative weight that the user is actually present at the appliance system.

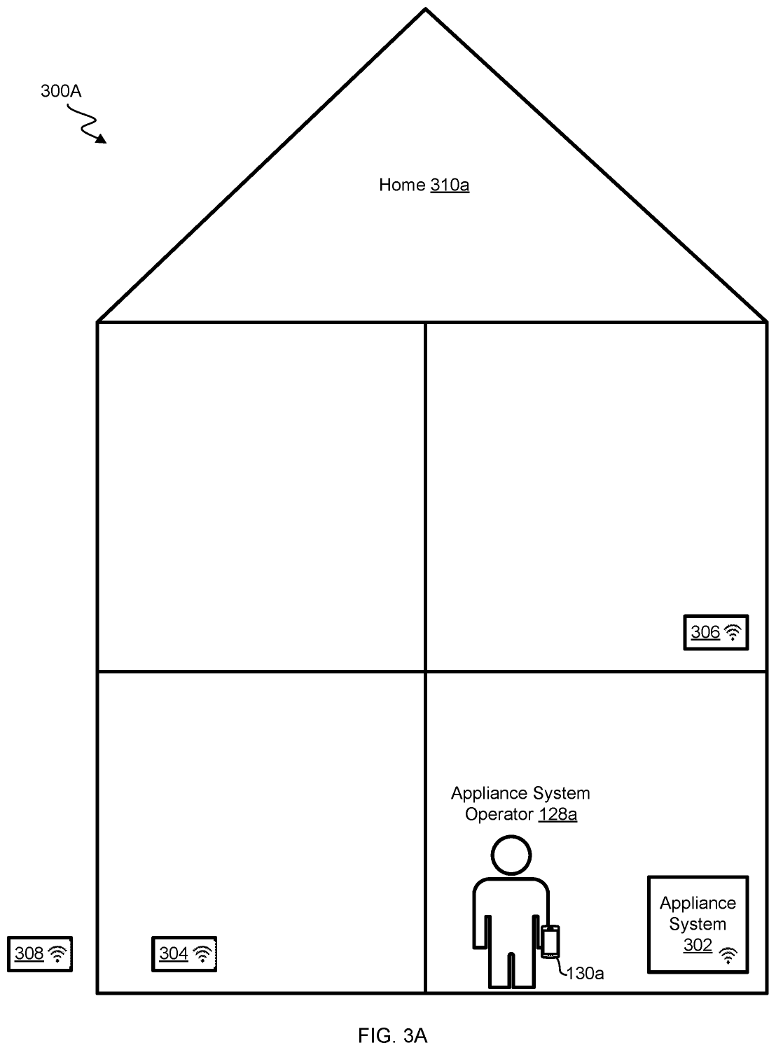

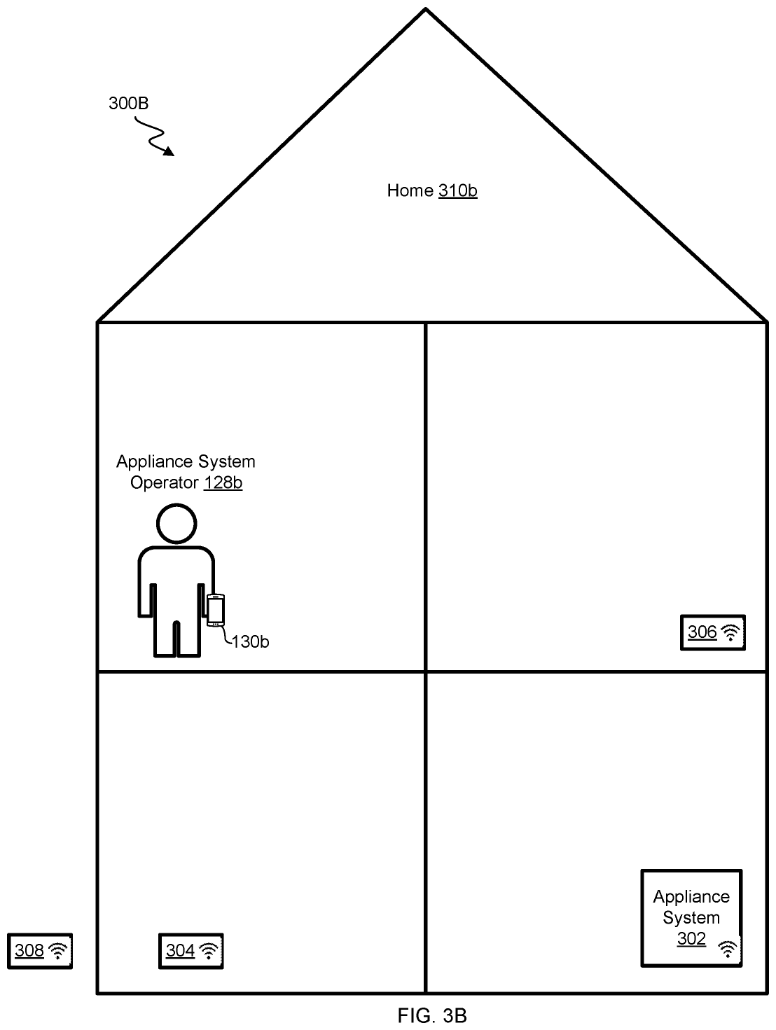

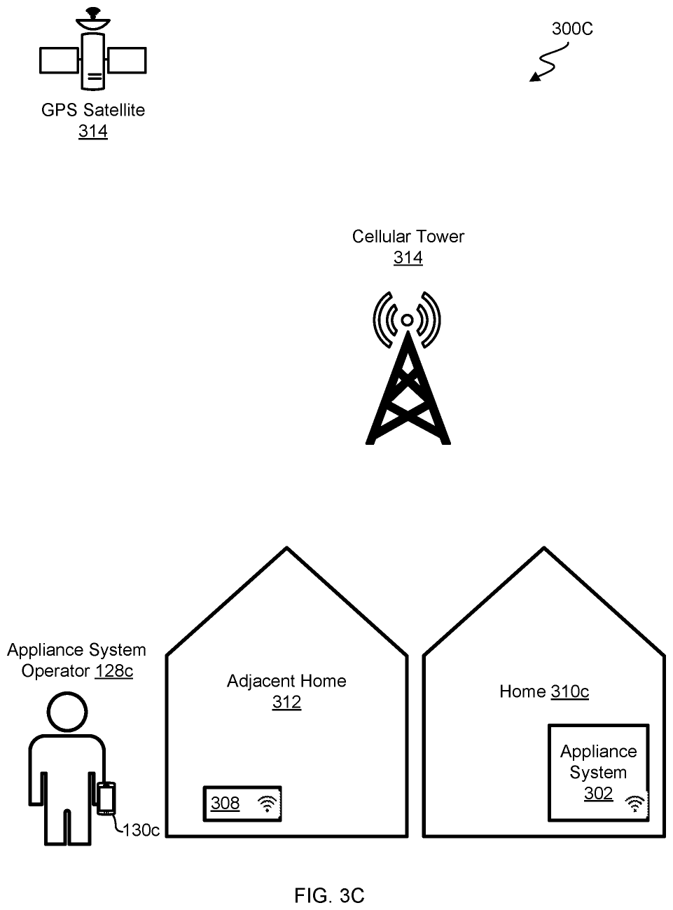

FIGS. 3A, 3B, and 3C illustrate a diagram of a building containing appliance system 302 and other beacons and signals nearby for determining whether an appliance system operator is present at appliance system 302. FIG. 3A shows environment 300A, where appliance system operator 128a is holding her or his smart phone 130a and standing near appliance system 302. In this example, smart phone 130a may have a strong signal from the wireless device on appliance system 302, a medium-strength signal from wireless devices 304 and 306 in other parts of the home 310a, and a weak signal from wireless device 308 outside of home 310a. Appliance system 302 and/or an application on smart phone 130a may associate those signal strengths with appliance system operator 128a being present at appliance system 302.

FIG. 3B shows environment 300B, where appliance system operator 128b is holding her or his smart phone 130b and standing inside home 310b but far from appliance system 302. In this example, smart phone 130b may have medium-strength signals from wireless devices 304 and 306 inside the home and wireless device 308 outside the home, but a weak signal or no signal at all from the wireless device on appliance system 302. Appliance system 302 and/or an application on smart phone 130b may associate those signal strengths with appliance system operator 128b being absent from appliance system 302, unless the active policy for appliance system 302 allows operator 128b to be marked as present even when standing so far away.

FIG. 3B shows environment 300C, where appliance system operator 128c is holding her or his smart phone 130c and standing outside home 310c and far from appliance system 302. In this example, smart phone 130c may have a strong signal from wireless device 308 of adjacent home 312, but weak or no signals from the wireless device on appliance system 302 or any other wireless device inside home 310c. Smart phone 130c may also have a strong signal from cellular tower 314, and signals from other cellular towers (not shown) that can be used to trilaterate a position of appliance system operator 128c well outside home 310c. Smart phone 130c may also have a strong signal from GPS satellite 314 and other GPS satellites (not shown) that can be also used to trilaterate a position of appliance system operator 12c well outside home 310c. Appliance system 302 and/or an application on smart phone 130c may associate those signal strengths and/or trilaterated positions of signal strengths, GPS locations, or cellular tower positions with appliance system operator 128c being absent from appliance system 302, unless the active policy for appliance system 302 allows operator 128c to be marked as present for a particularly low-risk appliance task even when standing that far away.

The different location metrics may be combined together to determine a particular estimated location of the appliance system operator and that particular estimated location is then compared to the actual location of the appliance system, a region containing the appliance system, or any other location relative to a location of the appliance system, in order to determine if the appliance system operator is present or not at the appliance system. In one embodiment, the appliance system stores a policy that determines how far away the user is allowed to be located in order to be considered present at the appliance system. This policy could be stored on the receiver subsystem and/or the transmitter subsystem, or on a server in the cloud remotely accessible to either subsystem. For example, if the appliance operator is 50 feet away from the appliance system and the policy limits attendance to 20 feet away from the appliance system, then the appliance operator is considered not attendant.

In one embodiment, under a configuration mode of the appliance system, a mobile device application user (who may also frequently be the appliance system operator, for example) interacts with a user interface on application of the mobile device to detect metrics and determine which metrics are stronger near the appliance system and which metrics are stronger away from the appliance system. In this manner, the mobile device application can better trilaterate and otherwise combine the metrics available to make a more accurate determination of whether the operator is near enough to the appliance system. In the configuration mode, the application may prompt the user to walk around the kitchen or other area immediately near, containing, or within visibility of the appliance system. Then, the application may prompt the user to walk to nearby areas that the user wants to consider as being “present” even if they are not in the same room or with direct visibility of the appliance system. Then, the application may prompt the user to walk to other floors of the house or building, other areas of the house or building, to the garage, and then outside of the house or building and even possibly outside of the neighborhood. As the user walks around, the application on the mobile device may detect various wireless beacon sources (e.g., Wi-Fi, Bluetooth, ZigBee, Z-wave, Bluetooth Low Energy, RFID, NFC, and/or Thread beacons) that are in proximity to the mobile device application user in various user-selected zones (e.g., area near appliance, area containing appliance, area within visibility of the appliance, in the same building or residence as appliance, immediately outside a building or residence, in a same neighborhood, and beyond the neighborhood). The application may record the presence, absence, and relative strengths of signals from these wireless beacon sources as metrics to later determine which zone the user is in and whether or not the user is considered present at the appliance system. For example, different zones of the appliance user may be considered as “present” for different wireless receiver subsystems and/or wireless transmitter subsystems depending on profiles specific to those subsystems.

Even without prompting the user to walk outside of the neighborhood, the application may detect that the user is outside of the neighborhood with high probability based on GPS locations determined at various times while the application is running. If the GPS location of the mobile device is very different than the appliance system's GPS location, for example, then other metrics, such as Wi-Fi and Bluetooth reachability metrics, may also be recorded as samples of those metrics that are far away. If the GPS location of the mobile device is very similar to the appliance system's GPS location, other metrics need to be taken into account. For example, detecting a car's Bluetooth connection may indicate that the user is in or near the car instead of being near the appliance system. Detecting a neighbor's Wi-Fi signal and a weakening or disappearing of the home Wi-Fi signal may indicate that the user is walking or driving away from the home. Detecting stronger connectivity with one access point in the home over another access point in the home may also signal that the user is present or not at the appliance system.

In one embodiment, the appliance system further includes Bluetooth beacons or other wireless beacons that can be plugged into various locations within the home to better trilaterate the appliance operator's position. Such beacons may already exist in the appliance system owner's household, such as wireless beacons on routers, refrigerators, personal assistant devices, etc., or may be added as moveable separate sensors unique to the appliance system. The mobile device application may instruct the user to place some beacons in the home away from the appliance system, and the appliance system itself may include a beacon that is co-located with the appliance system. In this way, the mobile device application can compare the strength of the wireless signals to determine which location is closer to the operator at a given time.

By using a configuration mode, the mobile device application can poll the available Wi-Fi networks and the connected or available Bluetooth devices, as well as other wireless signals, at various times when the user is known to be present or not present, and those metrics plus the GPS location, particularly if distinct from the home's GPS location, can feed into a determination of whether the user is present or not at the appliance system. The configuration mode can also account for nearby cameras or motion sensors detecting motion or people's faces or not, sound heard at personal assistant devices such as the Amazon Alexa™, Google Home™, or Apple HomePod™, and even whether certain smart lights or switches are turning on or off in the house. In one embodiment, the configuration mode of the application includes an “advanced” interface that allows the mobile device user to select or de-select signals that have been marked as relevant for determining the user's location. For example, if the user knows his neighbor frequently changes his Wi-Fi SSID, the user might not want to use the neighbor's Wi-Fi signal strength as a metric for determining whether or not the user is present at the appliance system.

Any data feeding into the mobile device or appliance system about the potential location of the user as the user moves around is considered a metric. The metrics can be combined with baseline data such as an installation address provided by the user for the appliance system. The baseline data does not change over time but is helpful for comparison with the metrics to determine the user's location.

In one embodiment, the mobile device application uses the configuration mode to train a machine learning model to predict whether the user is present or not at the appliance system. The signals detected and their strengths at each given location are fed into the model, which was trained on labeled data during the configuration phase, the labels indicating whether the combination of metrics reflects a “present” or “not present” state, or even “present,” “nearby,” and “far away” states. The mobile device application may seek feedback from the user in scenarios where the available metrics do not clearly indicate whether or not the user is present at the appliance system. In another example, the mobile device application, the appliance system itself, or a personal assistant device near the appliance system may provide an audible tone or other sound when (a) the appliance system is on, and (b) the appliance system operator is detected as leaving an area of the appliance system. In this manner, when the operator hears the tone, the mobile device application may also provide a pop-up notification or other user interface that allows the operator to provide feedback on whether the tone just played was correct or not. For example, if the operator hears the tone while standing next to the appliance system in the kitchen, the operator may open the mobile device application, select an option on the user interface of the application that says “I am present at the appliance system,” and proceed with the attended appliance task. Alternatively, the operator may indicate that the sound correctly indicated the operator is not attendant. The mobile device application may ingest this selected option as feedback to adjust the model to more correctly account for the detected metrics that led to the conclusion of the operator being present or not at the appliance system.

In the same or a different embodiment, the appliance system takes into account whether a mobile device of the operator or the operator's household is within reach of the appliance system. In this embodiment, the transmitter subsystem may receive encapsulated message(s) from a mobile device of the appliance system operator or a member of her or his household, and decapsulate the message(s) to determine that the operator is still within reach. When the operator becomes out of reach, her or his mobile device will no longer be able to send a short range (for example, Bluetooth) message to the appliance system, as the system would be unreachable. In this scenario, the mobile device could send a Wi-Fi or other longer range wireless message to the appliance system to indicate that the operator is out of reach; or, the appliance system could infer that the operator is out of reach by no longer receiving periodic presence messages from the operator. After failing to receive a later encapsulated presence message from the mobile device of the operator for a period of time after a prior particular presence message was received, the appliance system may mark the operator as not attendant to the appliance system.

Marking an operator as not attendant could trigger immediate disabling of the operational mode of wireless power transmission from the wireless power transmitter subsystem to the wireless power receiver subsystem. Alternatively, depending on a policy stored for the transmitter subsystem and/or the receiver subsystem, marking the operator as absent could trigger a sequence of events that may or may not result in disabling the operational mode of wireless power transmission. In one embodiment, marking the operator as absent triggers a pop-up notification on the operator's mobile device(s) registered with the appliance system or the mobile application. The pop-up notification may provide an option for the operator to mark herself or himself as present, for example, within a grace period of time before the appliance system becomes disabled by default. For example, the appliance system may be disabled if the operator marks, via the application, to disable the appliance system, or if the operator fails to mark any selection via the application within 10 seconds or some other grace period of time.

Regardless of how an operator is detected as present or not at the appliance system, the appliance system itself may trigger various risk mitigation strategies depending on the presence or not of the operator, how long the operator has been absent, how far away the operator is, and how dangerous the wireless power receiver subsystem's appliance task is when left unattended. For example, tasks with high heat or rapidly spinning blades may be shut down more readily even with lower confidence or time that the appliance operator has been marked absent. On the other hand, tasks with low heat or pressure, or tasks that are supposed to take several hours, such as the processes of a dehydrator or slow cooker, may be delayed longer before being shut down even after the appliance operator has been marked absent. In one configuration, some receiver subsystems and appliance tasks cause immediate appliance system shut down when the operator is marked absent; other receiver subsystems and appliance tasks cause a prompt of the mobile device user, via a mobile device user interface, and provide a grace period for reply when the operator is marked absent; and still other receiver subsystems and appliance tasks are ignored even though the operator is marked absent.

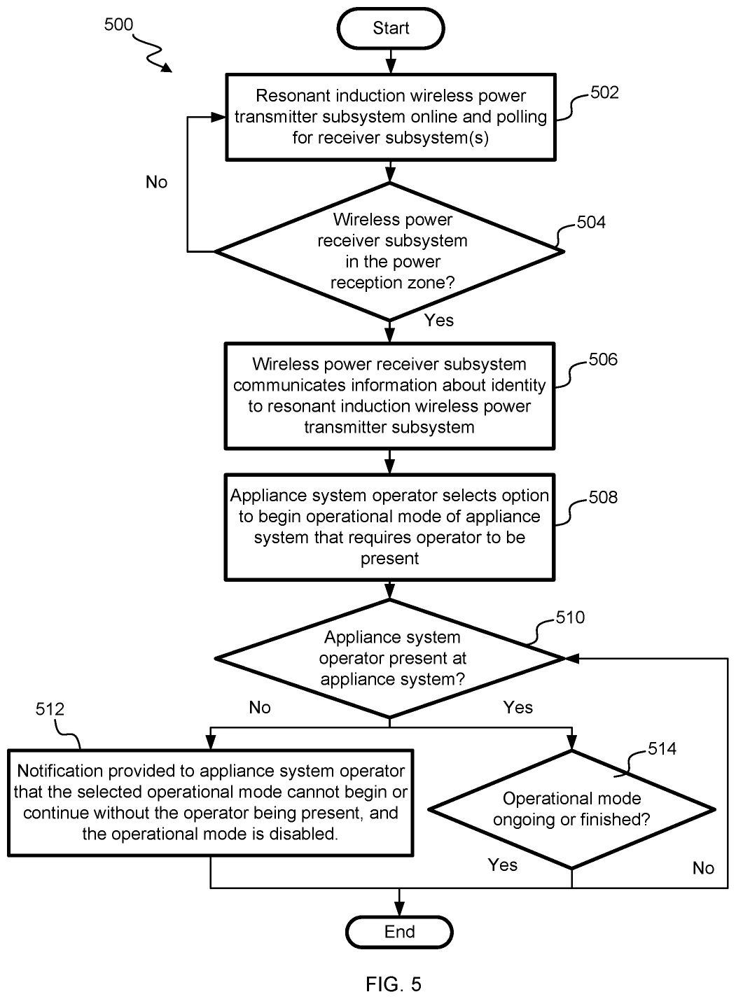

FIG. 5 illustrates a flow diagram of an embodiment of a process for disabling an induction appliance system when an operator is not present at the induction appliance system. The process starts at step 502, where resonant induction wireless power transmitter subsystem is online and polling for receiver subsystems. In step 504, the transmitter subsystem determines whether a receiver subsystem is in the power reception zone or not. If not, the transmitter subsystem returns to polling for receiver subsystems in step 502. If there is a receiver subsystem in the power reception zone, the process continues to step 506, where the receiver subsystem communicates information about the receiver subsystem's identity to the resonant induction wireless power transmitter subsystem. In 508, appliance system operator selects an option to begin an operational mode of the appliance system, such that a stored policy or trigger requires the operator to be present at the appliance system for the selected operational mode. In step 510, the resonant induction wireless power transmitter subsystem, or the receiver subsystem, or the smart phone application, or a server in communication with the transmitter subsystem determines whether an appliance system operator is present at the appliance system. If the appliance system operator is not present, in step 512 a notification is provided to the appliance system operator that the selected operational mode cannot begin or continue without the operator being present, and the operational mode is disabled. If the appliance system operator is present, on the other hand, the process continues in 514 where the operational mode is enabled, active, ongoing, and/or continuous in completing the appliance task.

The operational mode is considered active, and the appliance system is performing active work on the appliance task, while extra power (e.g., beyond an introductory level of power or a steady-state level of power used to power steady-state or always-available functionality such as a digital interface, LEDs, or a clock) is being consumed by the appliance to perform the appliance task. In various examples, a pot or pan on an induction cooktop is performing an active appliance task as the appliance system begins and continues to heat up food according to a specified setting on an induction cooktop. A blender is performing an active appliance task as the blender begins and continues to blend a mixture together. A toaster is performing an active appliance task as the toaster begins and continues to heat up food. A coffee maker is performing an active appliance task as the coffee maker begins and continues to brew coffee. A kettle is performing an active appliance task as the kettle begins and continues to warm up water. A rice cooker is performing an active appliance task as the rice cooker begins and continues to cook rice. The operational mode is considered active, and the appliance system is considered to be performing active work on the appliance task, even if the extra power being consumed is supplied intermittently over an interval of time dedicated to completing the appliance task. For example, a mixer performing active work on mixing may temporarily pause according to a selected mixing routine to allow the mixture to rest, and then resume to complete the task of mixing according to a specified setting. During the pause, the mixer is still in an active operational mode, ready to consume the additional power, even though the power is not being continuously supplied to the mixer over an entire interval covered by the appliance routine. In various other examples, such as heating a pan or toasting bread, power may be continuously supplied over the entire active interval covered by the appliance routine.

If the operational mode has not yet finished, the process returns to step 510, where another check is made whether the appliance system operator is present, and, if not, mitigation occurs in step 512. If the appliance system operator remains present, work continues until the operational mode is finished with the appliance task.

An appliance attendant rarely stands still in the kitchen. In one embodiment, the resonant induction appliance system detects that the appliance operator is not present at the resonant induction appliance system using a motion detector, camera, or face detector that is part of the wireless power transmitter subsystem, the wireless power receiver subsystem, or separately connected wirelessly (e.g., using a wireless communication protocol mentioned herein) to either the wireless power transmitter subsystem or wireless power receiver subsystem.

Many kitchens also include personal assistant devices, such as the Amazon Alexa™ Google Home™, or Apple HomePod™. These personal assistant devices can detect sounds and use the lack of detected sounds to determine that no one is present. The personal assistant devices could periodically reach out to the appliance operator to ensure the operator is still present. Alternatively or additionally, the personal assistant devices could prompt the appliance operator to verbally confirm he or she is present at key times, such as when other metrics indicate that the appliance operator may not be present.

If a pot boils over or a blender leaks, an attendant should be on-hand to mitigate the damage caused. In one embodiment, the resonant induction appliance system detects that the appliance operator is not present at the resonant induction appliance system by detecting a liquid has spilled on the surface that separates the wireless power transmitter subsystem and the wireless power receiver subsystem. The liquid spill can be detected in a variety of ways. In one embodiment, the surface has a small hole that feeds into a narrow basin of the wireless power transmitter subsystem, the basin having two or more electrodes with a voltage gap between them. If a threshold amount of current is detected between the electrodes, the resonant induction appliance system may conclude that water has spilled over on the counter and that an appliance operator is likely not present at the resonant induction appliance system. The basin may have a trap that can be emptied to reset the water spill detection mechanism. In another embodiment, electrodes may terminate in a channel, indentation, or even a flat portion of the surface, such that water spanning between the electrodes would trigger the water spill detection mechanism.

A receiver subsystem may have recipes or expected timing or temperature ranges associated with different operational modes. In one embodiment, the resonant induction appliance system detects that the appliance operator is not present at the resonant induction appliance system by detecting that the expected timing or temperature ranges have been exceeded, or have been exceeded to a certain degree or percentage. For example, if the attendant has selected the “air fry” function on an air fryer operational mode of a toaster oven (an example wireless receiver subsystem), the induction appliance system may access a stored profile for the toaster oven to determine that the air fry function is often active for 3-20 minutes and rarely active for over 30 minutes. In the example, based on detecting that the air fry function has been active for over 30 minutes on the wireless receiver subsystem, the wireless power transmitter subsystem may determine that the appliance operator is no longer present at the wireless power receiver subsystem. In another example, if the attendant has selected a “high heat” function on a frying pan, the wireless transmitter subsystem may access a stored profile for the frying pan to determine that temperature often ranges up to 450 degrees F. and rarely over 550 degrees F. In this example, based on detecting that the frying pan has reached or exceeded 550 degrees F., the wireless power transmitter subsystem may determine that the appliance operator is no longer present at the wireless power receiver subsystem.

### Mobile Application and Remotely Controlled Risk Mitigation for Unattended Appliances

A mobile application may be installed on a user's mobile device, such as the appliance operator's mobile device or mobile devices of member(s) of the appliance operator's family. The mobile device application can provide many functionalities for the appliance system via various user interfaces. In one user interface, the mobile device application organizes the wireless transmitter subsystem(s) and/or wireless receiver subsystem(s) owned by the user or appliance operator. The user can select an individual transmitter subsystem or receiver subsystem to drill into the settings specific to that subsystem. For example, drilling into the transmitter subsystem may allow the user to select or change default settings for how much power and/or at what frequency the transmitter subsystem should be allowed to deliver in different scenarios or at different times, for how long, with what types of receiver subsystems present or not, what triggers should cause different power delivery modes to be disabled, and/or what grace periods should be granted before disabling occurs. Drilling into the receiver subsystem may allow the user to select or change default settings for how much power and/or at what frequency the receiver subsystem should be given in different scenarios or at different times, for how long, with what types of transmitter subsystems delivering the power, what triggers should cause different power delivery modes to the receiver subsystem to be disabled, and/or what grace periods should be granted before disabling occurs. These drill-down interfaces allow settings to be specified per receiver subsystem type and/or per transmitter subsystem type, and the settings are stored in profiles comprising metadata about devices owned by the appliance system operator. The drill-down interfaces and profiles can even store settings specific to certain appliance operators, certain times of day, or certain scenarios that operate to change the safety mode of the appliance system under those circumstances.

The profiles may store settings specific to certain appliance operators who have authenticated into the system and/or candidate appliance operators who have not authenticated into the system. For example, the mobile application may have a profile that covers all unauthenticated users, which potentially covers children and pets who walk up to the appliance system when the appliance system is otherwise unattended. This profile may restrict operation to showing the time or performing basic safe tasks such as operating a warming drawer or a “keep warm” function on a toaster oven, and the settings are customizable per the appliance system owner's preference. Other profiles may cover authenticated users, such as users who have scanned their fingerprint at the appliance system, users whose face has been detected by a camera on the appliance system, or users who have punched in their passcode on a keypad of the appliance system. These authenticated users may be given extended functionality such as full operation of the device. In various scenarios, some users such as teenage residents may still have limited functionality available even when authenticated. For example, a teenage resident profile may include a setting that allows the user to perform basic toasting operations on a toaster oven but not to perform long-term baking operations on the toaster oven. Depending on the circumstances, the appliance system owner may customize user profiles and settings to fit her or his needs.

In one embodiment, the mobile application includes a preliminary notification interface that provides a notification, such as a pop-up notification, when the appliance system is potentially operating under unsafe conditions, such as when the appliance system is detected to be unattended. For example, the notification could say “Did you step away from the blender?Yes/No.” The notification may also include information about any appliance tasks in flight and how long those tasks have been in flight. The preliminary notification interface includes at least one response option for the appliance system operator to indicate that the resonant induction appliance system is operating under safe conditions, and possibly other options such as to ignore the message or indicate that the appliance system is operating under unsafe conditions. If the application fails to receive a selection within a grace period of time, or if the selection indicates that the appliance system is operating under unsafe conditions or otherwise does not indicate the appliance system is operating under safe conditions, the operational mode of the appliance system may be disabled, for example, by turning off the power delivery of the wireless transmitter subsystem and/or by turning off the power consumption of the wireless receiver subsystem.

In one embodiment, a mobile device user may fail to respond to a notification on the mobile device. For example, the appliance system may send a periodic notification such as “are you still there?” or a notification that occurs when unusual (though not impossible) behavior is detected, such as using a bake setting for over 2 hours. In these scenarios, if the mobile device user fails to respond to the notification, even if the mobile device is within a region considered as “attendant” to the appliance system, the appliance system may mark the appliance system operator as “not attendant” because the appliance system operator is apparently not co-located with her or his mobile device. In this example, the appliance system may be disabled according to the techniques described herein.

The mobile application may also include a configuration interface for setting up the process of determining whether the user is attendant at the appliance system or not. The configuration interface may prompt the user to walk around different areas of the house, building, or neighborhood, and may accept signal strength or availability readings from different devices directly accessible (e.g., Wi-Fi, Bluetooth, NFC, etc.) to the mobile device in the different areas, or from devices (e.g., cameras, personal assistant devices, smart switches, motion sensors, etc.) that are in wireless communication with the mobile device, for example, over an established Wi-Fi or cellular connection. These readings or metrics may be consumed after the user has walked around and used to determine whether the user is present or not at the appliance system at a given time. The configuration interface may feed these readings into a machine learning algorithm to build a model that determines whether the user is present or not at the appliance system in different scenarios. In another example, the configuration interface may establish heuristics that determine whether the user is present or not at the appliance system in different scenarios. The user interface may provide options for the user to include or exclude certain metrics from consideration. For example, the user may exclude certain wireless signals from consideration if the user does not know about how or where the wireless signal is coming from, or how reliable the wireless signal will be in the future for predicting a location of the user. In one embodiment, the user interface even allows the user to adjust the weights given to different signals in determining whether the user is present or not at the appliance system.

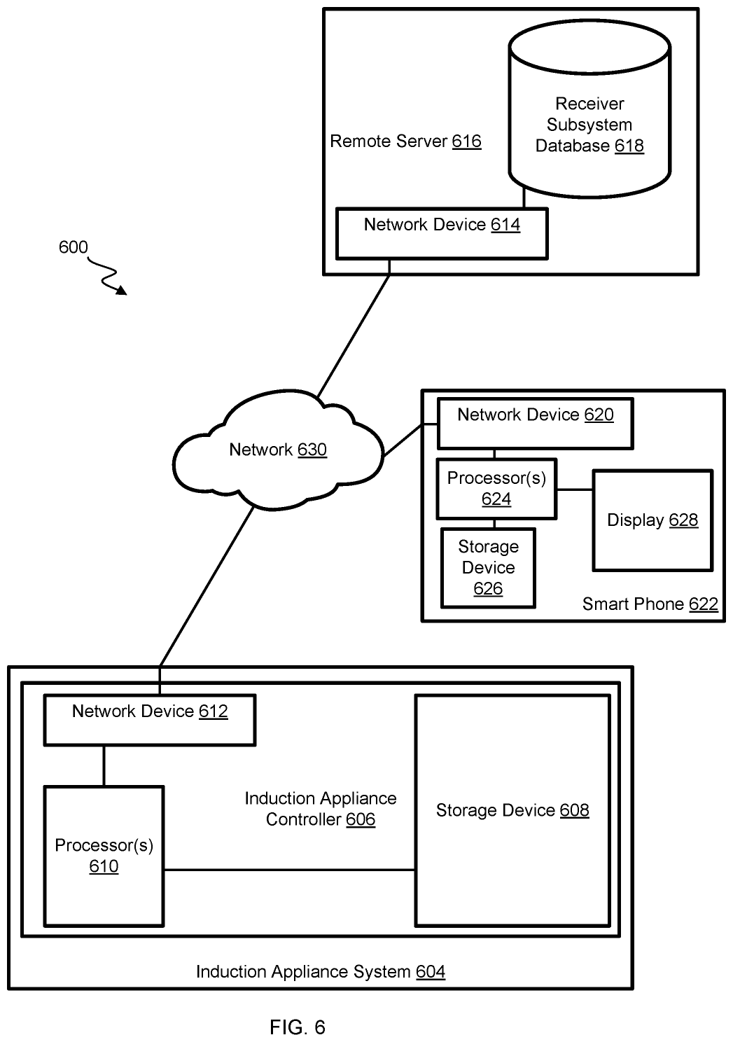

FIG. 6 illustrates a network diagram of an embodiment of a networked system 600 that includes an induction appliance controller 606 in communication over network 630 with a smart phone 622 and a remote server 616 to control an induction appliance system 604. Induction appliance system 604 includes induction appliance controller 606, which network device 612 to communicate via network 630 with other devices in networked system 600, and uses storage device 608 to store information, such as profiles, policies, and metadata, received so the information can be applied to manage induction appliance system according to processor(s) 610 executing according to instructions stored on storage devices 608.

Also as shown in FIG. 6, remote server 616 includes network device 614 for communicating over the network 630 with other devices in networked system 600. Remote server 616 also includes receiver subsystem database 618 for storing and retrieving triggers, profiles, and policies specific to different receiver subsystems. Smart phone 622 is also connected to network 630, via network device 620. Smart phone 622 also includes display 628 for providing notifications to an appliance operator, as well as for receiving preferences from the appliance operator about triggers, profiles, and policies. Such preferences may be stored in receiver subsystem database 618 or in storage device 626 of smart phone 622. Smart phone 622 uses processors that execute instructions stored in storage device 626, in the form of an application, to prompt the user for input about triggers, profiles, and policies, as well as notify the user about appliance systems that are in operational mode but left unattended.

### Device-Specific Automatic Risk Mitigation

In one embodiment, once the wireless power transmitter subsystem is able to detect wireless power receiver subsystems, the wireless power transmitter subsystem can support and even distinguish how power is provided to a plurality of different candidate types of wireless power receiver subsystems. The wireless power transmitter subsystem may identify the wireless power receiver subsystem by an encapsulated message sent from the wireless power receiver subsystem or a user's mobile device according to a wireless communication protocol, or by a message embedded in the variable impedance imposed by the wireless power receiver subsystem. The message may be decapsulated from the marked header or other wrapper to determine an identity of the wireless power receiver subsystem among the plurality of different candidate wireless power receiver subsystems. The identity of wireless power receiver subsystem may impact which trigger is applied when the appliance operator is detected as being absent. The wireless power transmitter subsystem may look up the trigger based on the identity of wireless power receiver subsystem, for example, in a wireless power receiver subsystem database, in order to determine what trigger to apply, how much power and/or at what frequency the receiver subsystem should be given in different scenarios or at different times, for how long, whether the transmitter subsystem is a valid subsystem for delivering the power, what triggers should cause different power delivery modes to the receiver subsystem to be disabled, and/or what grace periods should be granted before disabling occurs.

In one embodiment, the wireless power transmitter subsystem determines that the operational mode of the appliance system is associated with a particular operational mode of a plurality of different candidate operational modes of the wireless power receiver subsystem. For example, the transmitter subsystem may determine that a kettle is being used to boil water. In the example, the trigger may indicate that the particular operational mode of the wireless power receiver subsystem (i.e., the kettle boiling water) should be disabled when the induction appliance system operator is not present at the resonant induction appliance system after a grace period of time (for example, 5 minutes). Some kettles even whistle when they are boiling, in which case the grace period might be decreased to prevent long periods of loud whistling when the device is unattended. If the device is unattended before the grace period has been met, the transmitter subsystem, mobile device, or receiver subsystem may postpone the disabling of the operational mode until the criteria of the trigger has been met. At a later time, if the device is still determined to be unattended and the grace period has been met, the transmitter subsystem, mobile device, or receiver subsystem may disable the operational mode to, for example, stop the heat from being applied to boil the water.

Each trigger may be specific to the device, such that a user can set up different rules for a toaster, a blender, a frying pan, a slow cooker, and a kettle. The metadata can be stored in a profile of the device, indicating how much power and/or at what frequency the receiver subsystem should be given in different scenarios or at different times, for how long, whether the transmitter subsystem is a valid subsystem for delivering the power, what triggers should cause different power delivery modes to the receiver subsystem to be disabled, and/or what grace periods should be granted before disabling occurs. The metadata and/or device disabling policies can be stored on a server, accessible to the mobile application, the transmitter subsystem, or the receiver subsystem. Alternatively, the metadata device disabling policies can be stored on the transmitter subsystem, the receiver subsystem, or on the mobile device itself, accessible to others of the mobile application, the transmitter subsystem, and/or the receiver subsystem so the metadata can be used to carry out disabling of the power transmission in the scenario covered by the metadata and/or device disabling policies.

In one embodiment, the region which is considered “present” at the appliance system depends on the profile of the receiver subsystem that is in the operational mode. For example, a dehydrator operating over a long period of time may have a larger radius that is considered “present” than an air fryer operating at high temperatures for a short period of time. Information about the extent of the region considered for presence, or a scaling up or down of a default region, may be stored in the metadata for the profile of the receiver subsystem.

In one embodiment, safety profiles may be stored generically with respect to all receiver subsystems. For example, one profile may specify certain disabling rules, regions, or other policies that are effective for operational modes that involve temperatures of under a threshold temperature (e.g., 120 degrees), and other rules, regions, or policies for operational modes that involve temperatures over the threshold temperature. For example, devices over 120 degrees may have a very short grace period (e.g., 2 minutes), and devices under 120 degrees may have a very long grace period (e.g., 2 hours). In another example, a profile may apply to devices that are not in an operational mode, such as receiver subsystems that are in a standby mode where lights, clock, and basic data retention features are enabled but appliance tasks are disabled. This profile may allow the receiver subsystem to remain unattended indefinitely without any notification, for example.

In one embodiment, the type of receiver subsystem is detected using artificial intelligence based on metrics gathered about the receiver subsystem. For example, a temperature sensor on a surface of the transmitter subsystem may indicate that the receiver subsystem is heating up to a certain temperature and remaining at or exceeding that temperature for a certain amount of time. As another example, although a high amount of power is being supplied, the temperature of the receiver subsystem may not be increasing significantly over time. Other sensors such as a microphone may indicate a volume level of the receiver subsystem in operational mode. A loud receiver subsystem that is not heating up over time, for example, may be identified as a blender. This information can be fed into a pre-trained model or heuristics to indicate what receiver subsystem is likely connected to the wireless transmitter subsystem. Depending on the identified receiver subsystem, default metadata, disabling rules, or other policies may apply to restrict operation of the wireless receiver subsystem.

In one embodiment, the profiles of wireless transmitter subsystem(s) and/or wireless receiver subsystem(s) may be restrained based on local laws associated with an address of the appliance system. For example, local laws may prevent certain devices, such as toaster ovens, from being used at certain temperatures for an extended period of time. In this scenario, regardless of the profile settings for the toaster oven, the wireless transmitter subsystem(s) may disable power to the wireless receiver subsystem when the limits of a local law have been reached.

In another embodiment, the profiles of wireless transmitter subsystem(s) and/or wireless receiver subsystem(s) may be restrained depending on the operator attendant to the appliance system. If the operator logs into the appliance system with a pass code or pin, for example, either on the appliance system itself or via the mobile device application, the operator may be constrained to perform only those functions that the owner of the appliance system has configured for them. Protecting functionality of receiver subsystems with a passcode or pin can prevent children, disabled, or elderly people from operating devices that are beyond their means, further contributing to the safety of the appliance system.

### Controllers, Processors, and Storage

Various embodiments described herein are implemented by processors operating on stored data according to instructions or rules. These embodiments can be implemented with a controller or microcontroller connected to a non-transitory computer-readable storage medium, such as a storage device (e.g., a hard disk drive, computer memory, a solid state drive, a Flash drive, SD card, or other memory card), and optionally one or more communication devices, such as a network device or cellular device. Network devices are capable of communicating with each other over long or short distances, which allows data to be reliably passed between separate components. Various examples of wireless communication discussed herein include but are not limited to Wi-Fi, Bluetooth, ZigBee, Z-wave, Bluetooth Low Energy, RFID, NFC, and/or Thread network communications, etc. New forms of network communication are developed each day, and the techniques described herein are not intended to be limited to a specific form of network communication unless otherwise claimed. For example, this allows information from the mobile device application to be reliably communicated to the wireless transmitter subsystem and/or wireless receiver subsystem, and vice versa. This also allows these components to reliably communicate with a server for remotely storing information in a manner that does not rely on the connectivity or uptime of any of these individual components. In a practical example, the server would be maintained by a manufacturer of the receiver subsystem or transmitter subsystem.

As referred to herein, appliance control components, software or stored instructions may be used to perform operations with respect to metrics or other fields or values from same or different devices, from storage devices, including, for example, databases hosted on devices, and as the output of other stored instructions. The appliance control components, software or stored instructions may be on physical devices such as non-transitory computer-readable storage media, so that one or more processors can access the instructions to cause machines to perform processes. The machines themselves typically have application programming interfaces or control interfaces for causing certain functionality of the machine with the ability to pass in certain variable parameters that indicate how the functionality will be carried out on the machine. The individual machines receive commands via these control interfaces and have processors internal to the machines that carry out the individual commands according to the machine's manufactured specifications.

Specific details are given in the above description to provide a thorough understanding of the embodiments. However, it is understood that the embodiments may be practiced without these specific details. For example, components may be shown in block diagrams in order not to obscure the embodiments in unrequired detail. In other instances, well-known circuits, processes, algorithms, structures, and techniques may be shown without unrequired detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

In the embodiments described above, for the purposes of illustration, processes may have been described in a particular order. It may be appreciated that in alternate embodiments, the methods may be performed in a different order than that described. It may also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data. These machine-readable instructions may be stored on one or more machine-readable mediums, such as compact disc read-only memory (CD-ROMs) or other type of optical disks, solid-state drives, tape cartridges, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the required tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to some configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, the technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate when discussing the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate when discussing the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made by way of example and not as limitation on the scope of the disclosure.

We claim:

1. A method comprising:
determining that an appliance system operator is present at a resonant induction appliance system comprising a wireless power receiver subsystem removably in a wireless power reception zone of a wireless power transmitter subsystem; wherein the wireless power receiver subsystem comprises a wireless power receiver; wherein the wireless power transmitter subsystem comprises a wireless power transmitter; wherein, when the resonant induction appliance system is in an operational mode, the wireless power transmitter delivers enough wireless power to the wireless power receiver subsystem to allow the wireless power receiver subsystem to perform active work on an appliance task, such that the wireless power receiver subsystem consumes received power from the wireless power transmitter to perform the active work on the appliance task;
to promote safe operation of the resonant induction appliance system, based on determining that the appliance system operator is present at the resonant induction appliance system, enabling the operational mode of the resonant induction appliance system to cause the wireless power transmitter to deliver enough wireless power to the wireless power receiver to allow the wireless power receiver subsystem to perform the active work on the appliance task, such that the wireless power receiver subsystem consumes the received power from the wireless power transmitter to perform the active work on the appliance task;
determining that the appliance system operator is no longer present at the resonant induction appliance system based on at least one metric collected using at least one device that is also not present at the resonant induction appliance system;
accessing a stored trigger to determine that the trigger indicates that the operational mode of the resonant induction appliance system should be disabled based at least in part on the appliance system operator not being present at the resonant induction appliance system, wherein the trigger promotes safe operation of the resonant induction appliance system by preventing potentially unattended work by the wireless power receiver subsystem on the appliance task;
in response to determining that the appliance system operator is no longer present at the resonant induction appliance system and that the trigger indicates that the operational mode of the resonant induction appliance system should be disabled based at least in part on the appliance system operator not being present at the resonant induction appliance system:
disabling the operational mode of the resonant induction appliance system to cause the wireless power transmitter to stop delivering enough wireless power to the wireless power receiver subsystem for the wireless power receiver subsystem to perform the potentially unattended work on the appliance task, such that the wireless power receiver subsystem stops the potentially unattended work on the appliance task; and
triggering a notification that the operational mode of the resonant induction appliance system has been disabled to stop the potentially unattended work by the wireless power receiver subsystem on the appliance task.

2. The method of claim 1, wherein said determining that the appliance system operator is present at the resonant induction appliance system comprises detecting that the wireless power receiver subsystem has been newly placed in the wireless power reception zone of the wireless power transmitter subsystem.

3. The method of claim 1, wherein the wireless power receiver subsystem converts at least some of the received power into a current; wherein the wireless power receiver subsystem further comprises an electric appliance having a physical interface; wherein the current is consumed by the electric appliance to perform the active work on the appliance task; and wherein said determining that the appliance system operator is present at the resonant induction appliance system comprises detecting a physical interaction from the appliance system operator with the physical interface of the electric appliance.

4. The method of claim 1, wherein the wireless power transmitter subsystem comprises a physical interface, wherein the wireless power receiver subsystem converts at least some of the received power into heat, wherein the heat causes one or more surfaces of the wireless power receiver subsystem to increase in temperature enough to perform the active work on the appliance task, and wherein said determining that the appliance system operator is present at the resonant induction appliance system comprises detecting a physical interaction from the appliance system operator with the physical interface of the wireless power transmitter subsystem.

5. The method of claim 1, further comprising:
determining a trilaterated position of a mobile device of the appliance system operator;
wherein said determining that the appliance system operator is no longer present at the resonant induction appliance system comprises:
comparing the trilaterated position to one or more stored positions relative to a location of the resonant induction appliance system; and
accessing a stored policy to determine whether the trilaterated position is considered present at the resonant induction appliance system.

6. The method of claim 1, further comprising:
the wireless power transmitter subsystem wirelessly receiving a particular encapsulated presence message from a mobile device of the appliance system operator;
the wireless power transmitter subsystem decapsulating the particular presence message to determine that the appliance system operator is present at the resonant induction appliance system;
wherein said determining that the appliance system operator is no longer present at the resonant induction appliance system comprises the wireless power transmitter subsystem failing to receive a later encapsulated presence message from the mobile device of the appliance system operator for a period of time after the particular encapsulated presence message was received.

7. The method of claim 1, wherein the wireless power transmitter subsystem supports a plurality of different candidate wireless power receiver subsystems, the method further comprising:
the wireless power transmitter subsystem wirelessly receiving an encapsulated message from the wireless power receiver subsystem;
the wireless power transmitter subsystem decapsulating the message to determine an identity of the wireless power receiver subsystem among the plurality of different candidate wireless power receiver subsystems; and
wherein said accessing the trigger comprises looking up the trigger based at least in part on the identity of the wireless power receiver subsystem.

8. The method of claim 7, further comprising:
determining that the operational mode of the resonant induction appliance system is associated with a particular operational mode of a plurality of different candidate operational modes of the wireless power receiver subsystem;
wherein the trigger indicates that the particular operational mode of the wireless power receiver subsystem should be disabled when the appliance system operator is not present at the resonant induction appliance system after a grace period of time;
determining that the grace period of time is not yet met, and, based on the grace period indicated by the trigger, postponing the disabling of the operational mode of the resonant induction appliance system;
determining that the grace period of time is met; wherein said disabling the operational mode of the resonant induction appliance system is based at least in part on determining that the grace period of time is met.

9. The method of claim 8, further comprising:
before the grace period of time is met and after said determining that the appliance system operator is no longer present at the resonant induction appliance system, outputting, on a mobile device of the appliance system operator, a preliminary notification that indicates the resonant induction appliance system is potentially operating under unsafe conditions;
wherein the preliminary notification comprises a user interface on the mobile device, wherein the user interface comprises at least one response option for the appliance system operator to indicate that the resonant induction appliance system is operating under safe conditions;
wherein said disabling the operational mode of the resonant induction appliance system is performed after the appliance system operator fails to indicate, via the user interface, that the resonant induction appliance system is operating under safe conditions.

10. A resonant induction appliance wireless power transmitter subsystem comprising:
a wireless power transmitter comprising a coil coupled with a series capacitor in a resonant chamber, the resonant chamber operatively connected to a power inverter;
the wireless power transmitter positioned to provide wireless power to a wireless power reception zone where a wireless power receiver subsystem can be removably placed; wherein, when the resonant induction appliance wireless power transmitter subsystem is placed in an operational mode, the wireless power transmitter delivers enough wireless power to the wireless power receiver subsystem to allow the wireless power receiver subsystem to perform active work on an appliance task, such that the wireless power receiver subsystem consumes received power from the wireless power transmitter to perform the active work on the appliance task;
one or more processors;
one or more non-transitory computer-readable media storing instructions, the instructions which, when executed by the one or more processors, cause determining that the appliance system operator is present at the resonant induction appliance system comprising the resonant induction appliance wireless power transmitter subsystem and the wireless power receiver subsystem so that the operational mode of the resonant induction appliance wireless power transmitter subsystem can be enabled to cause the wireless power transmitter to deliver enough wireless power to the wireless power receiver to allow the wireless power receiver subsystem to perform the active work on the appliance task, such that the wireless power receiver subsystem consumes the received power from the wireless power transmitter to perform the active work on the appliance task;
the one or more processors operatively connected to one or more wireless communication devices to receive at least one metric collected using at least one device that is not present at the resonant induction appliance system, the at least one metric indicating that the appliance system operator is no longer present at the resonant induction appliance system;
the one or more non-transitory computer-readable media further storing instructions, which, when executed by the one or more processors, cause:
accessing a stored trigger to determine that the trigger indicates that the operational mode of the resonant induction appliance system should be disabled based at least in part on the appliance system operator not being present at the resonant induction appliance system, wherein the trigger promotes safe operation of the resonant induction appliance system by preventing potentially unattended work by the wireless power receiver subsystem on the appliance task;
in response to determining that the appliance system operator is no longer present at the resonant induction appliance system and that the trigger indicates that the operational mode of the resonant induction appliance system should be disabled based at least in part on the appliance system operator not being present at the resonant induction appliance system, disabling the operational mode of the resonant induction appliance system to cause the wireless power transmitter stopping delivery of enough wireless power to the wireless power receiver subsystem for the wireless power receiver subsystem to perform the potentially unattended work on the appliance task, such that the wireless power receiver subsystem stops the potentially unattended work on the appliance task; and
triggering a notification that the operational mode of the resonant induction appliance system has been disabled to stop the potentially unattended work by the wireless power receiver subsystem on the appliance task.

11. The resonant induction appliance wireless power transmitter subsystem of claim 10, further comprising the wireless power receiver subsystem that is removably placed in the wireless power reception zone, wherein the wireless power receiver subsystem comprises a receiver coil to convert at least some of the wireless power from the resonant induction appliance wireless power transmitter subsystem into a current; wherein the wireless power receiver subsystem further comprises an electric appliance having a physical interface to cause the electric appliance to use the current to perform the active work on the appliance task; and wherein the one or more instructions that cause said determining that the appliance system operator is present at the resonant induction appliance system are implemented at least in part by detecting a physical interaction from the appliance system operator with the physical interface of the electric appliance.

12. The resonant induction appliance wireless power transmitter subsystem of claim 10, wherein the resonant induction appliance wireless power transmitter subsystem comprises a physical interface, and wherein the one or more instructions that cause said determining that the appliance system operator is present at the resonant induction appliance system are implemented at least in part by detecting a physical interaction from the appliance system operator with the physical interface of the resonant induction appliance wireless power transmitter subsystem, and wherein the physical interaction with the physical interface is operable to cause one or more surfaces of the wireless power receiver subsystem to heat up by increasing in temperature enough to perform the active work on the appliance task.

13. The resonant induction appliance wireless power transmitter subsystem of claim 10, the one or more non-transitory computer-readable media further storing instructions, which, when executed by the one or more processors, cause determining a trilaterated position of a mobile device of the appliance system operator; wherein the one or more instructions that cause said determining that the appliance system operator is no longer present at the resonant induction appliance system are implemented at least in part by:
comparing the trilaterated position to one or more stored positions relative to a location of the resonant induction appliance system; and
accessing a stored policy to determine whether the trilaterated position is considered present at the resonant induction appliance system.

14. The resonant induction appliance wireless power transmitter subsystem of claim 10, wherein the resonant induction appliance wireless power transmitter subsystem supports a plurality of different wireless power receiver subsystems, the one or more wireless communication devices further configured to wirelessly receive an encapsulated message from the wireless power receiver subsystem, wherein the one or more instructions, when executed by the one or more processors, further cause decapsulating the message to determine an identity of the wireless power receiver subsystem among the plurality of different wireless power receiver subsystems; and wherein the one or more instructions that cause said accessing the trigger are implemented at least in part by looking up the trigger based at least in part on the identity of the wireless power receiver subsystem.

15. The resonant induction appliance wireless power transmitter subsystem of claim 14, wherein the non-transitory computer-readable media further store instructions which, when executed by the one or more processors, cause:
determining that the operational mode of the resonant induction appliance wireless power transmitter subsystem is associated with a particular operational mode of a plurality of different candidate operational modes of the wireless power receiver subsystem;
wherein the trigger indicates that the particular operational mode of the wireless power receiver subsystem should be disabled when the induction appliance system operator is not present at the resonant induction appliance system after a grace period of time;
determining that the grace period of time is not yet met, and, based on the grace period indicated by the trigger, postponing said disabling of the operational mode of the resonant induction appliance wireless power transmitter subsystem;
determining that the grace period of time is met; wherein said disabling the operational mode of the resonant induction appliance wireless power transmitter subsystem is based at least in part on determining that the grace period of time is met.

16. The resonant induction appliance wireless power transmitter subsystem of claim 15, wherein the non-transitory computer-readable media further store instructions which when executed by the one or more processors, cause:
before the grace period of time is met and after determining that the appliance system operator is no longer present at the resonant induction appliance system, outputting, on a mobile device user interface of the appliance system operator, a preliminary notification that indicates the resonant induction appliance system is potentially operating under unsafe conditions; wherein said disabling the operational mode of the resonant induction appliance system is configured to be caused after the appliance system operator fails to indicate, via the mobile device user interface, that the resonant induction appliance system is operating under safe conditions.

17. One or more non-transitory machine-readable storage media storing instructions which, when executed by one or more processors, cause:
determining that an appliance system operator is present at a resonant induction appliance system comprising a wireless power receiver subsystem removably in a wireless power reception zone of a wireless power transmitter subsystem; wherein the wireless power receiver subsystem comprises a wireless power receiver; wherein the wireless power transmitter subsystem comprises a wireless power transmitter; wherein, when the resonant induction appliance system is in an operational mode, the wireless power transmitter delivers enough wireless power to the wireless power receiver subsystem to allow the wireless power receiver subsystem to perform active work on an appliance task, such that the wireless power receiver subsystem consumes received power from the wireless power transmitter to perform the active work on the appliance task;
to promote safe operation of the resonant induction appliance system, based on determining that the appliance system operator is present at the resonant induction appliance system, enabling the operational mode of the resonant induction appliance system to cause the wireless power transmitter to deliver enough wireless power to the wireless power receiver to allow the wireless power receiver subsystem to perform the active work on the appliance task, such that the wireless power receiver subsystem consumes the received power from the wireless power transmitter to perform the active work on the appliance task;
determining that the appliance system operator is no longer present at the resonant induction appliance system based on at least one metric collected using at least one device that is also not present at the resonant induction appliance system;
accessing a stored trigger to determine that the trigger indicates that the operational mode of the resonant induction appliance system should be disabled based at least in part on the appliance system operator not being present at the resonant induction appliance system, wherein the trigger promotes safe operation of the resonant induction appliance system by preventing potentially unattended work by the wireless power receiver subsystem on the appliance task;
in response to determining that the appliance system operator is no longer present at the resonant induction appliance system and that the trigger indicates that the operational mode of the resonant induction appliance system should be disabled based at least in part on the appliance system operator not being present at the resonant induction appliance system:
disabling the operational mode of the resonant induction appliance system to cause
the wireless power transmitter to stop delivering enough wireless power to the wireless power receiver subsystem for the wireless power receiver subsystem to perform the potentially unattended work on the appliance task, such that the wireless power receiver subsystem stops the potentially unattended work on the appliance task; and
triggering a notification that the operational mode of the resonant induction appliance system has been disabled to stop the potentially unattended work by the wireless power receiver subsystem on the appliance task.

18. The one or more non-transitory machine-readable media of claim 17, wherein the wireless power receiver subsystem converts at least some of the received power into a current; wherein the wireless power receiver subsystem further comprises an electric appliance having a physical interface; wherein the current is consumed by the electric appliance to perform the active work on the appliance task; and wherein said determining that the appliance system operator is present at the resonant induction appliance system comprises detecting a physical interaction from the appliance system operator with the physical interface of the electric appliance.

19. The one or more non-transitory machine-readable media of claim 17, wherein the wireless power transmitter subsystem comprises a physical interface, wherein the wireless power receiver subsystem converts at least some of the received power into heat, wherein the heat causes one or more surfaces of the wireless power receiver subsystem to increase in temperature enough to perform the active work on the appliance task, and wherein said determining that the appliance system operator is present at the resonant induction appliance system comprises detecting a physical interaction from the appliance system operator with the physical interface of the wireless power transmitter subsystem.

20. The one or more non-transitory machine-readable media of claim 17, wherein the instructions, when executed by the one or more processors, further cause:
determining a trilaterated position of a mobile device of the appliance system operator;
wherein said determining that the appliance system operator is no longer present at the resonant induction appliance system comprises:
comparing the trilaterated position to one or more stored positions relative to a location of the resonant induction appliance system; and
accessing a stored policy to determine whether the trilaterated position is considered present at the resonant induction appliance system.
